(19) United States
(12) Patent Application Publication
(10) Pub. No.: US 2026/0180134 A1
(43) Pub. Date: Jun. 25, 2026

(54) BATTERY CELL INTERCONNECTION ARCHITECTURE FOR MITIGATING SHORT CIRCUITS

(71) Applicant: GM GLOBAL TECHNOLOGY OPERATIONS LLC, Detroit, MI (US)

(72) Inventors: Ziliang Zheng, Auburn Hills, MI (US); Fengkun Wang, Rochester Hills, MI (US); Ryan Patrick Hickey, Austin, TX (US); Wei Zeng, Oakland Township, MI (US); Dingfeng Deng, Auburn Hills, MI (US); Anil Yadav, Troy, MI (US); Krishna Guntur, LaSalle (CA); Syed Moez Hussain Mahmood, Farmington Hills, MI (US); Charles Opie, Berkley, MI (US); Wade G. Johnson, Oxford, MI (US)

(73) Assignee: GM GLOBAL TECHNOLOGY OPERATIONS LLC, Detroit, MI (US)

(21) Appl. No.: 18/989,504

(22) Filed: Dec. 20, 2024

(51) Int. Cl. H01M 50/509; H01M 50/507; H01M 50/583

(52) U.S. Cl. CPC H01M 50/509; H01M 50/507; H01M 50/583; H01M 2220/20

(57) ABSTRACT

Electrical interconnection architectures for electrically connecting stacked prismatic battery modules in various combinations of parallel and series configurations that distribute heat sources (e.g., heat conduction through a busbar, and internal resistance heating from short circuiting) to multiple battery cells, rather than to a single adjacent cell, thereby reducing thermal excursion propagation. Examples of interconnection architectures include various combinations of overlap bus and bypass bus configurations. A two-parallel module configuration may have two serial sub-modules with cells connected in a staggered interconnection pattern. A busbar connection pattern may allow the negative inlet and positive outlet to be located on the same end of a battery module. Battery cells may be interconnected so that a parallel cell is not an adjacent cell. Various combinations of resistors and fuses may also be used to reduce overheating from short circuiting.

### INTRODUCTION

This disclosure relates to various prismatic battery cell interconnection architectures used for battery-electric or hybrid-electric automotive vehicles, and other battery-powered applications, which are passively resistant to battery cell-to-cell short circuiting that may overheat adjacent battery cells.

The Rechargeable Energy Storage System (RESS) used in electric vehicles (EVs) achieves a desired operating performance by electrically interconnecting several battery cells using a combination of series and parallel electrical connections. Each cell interconnected in a single serial string of battery cells adds up each cell's individual voltage potential to reach a desired total terminal voltage for the single series string. Parallel interconnections, on the other hand, generate a higher total energy capacity by adding up the ampere-hour (Ah) Columbic capacity of multiple strings of battery cells connected in series.

For example, a battery module with four battery cells may be electrically connected as one Parallel group and four Series group (i.e., a “1P4S” battery architecture). A second example of a battery module with eight battery cells may be electrically connected as two Parallel groups and four Series groups (i.e., a “2P4S” battery architecture).

Battery pack designs may be configured to optimize the overall thermal performance in both normal and thermal excursion conditions. Such thermal optimization may also increase the total energy density of the battery pack, while reducing the overall pack space that is dedicated to the use of thermal barriers that may be placed in-between adjacent battery cells. Shorting of interconnected battery cell circuits may cause internal resistance heating that rapidly increases cell temperatures in thermal excursion event. An “in-rush” or shorting current may exceed a maximum discharging current by up to 70% under nominal operating conditions. Such a high shorting current, and conduction of heat through an electrical busbar, may introduce excess heat to immediately adjacent cells, subsequently increasing cell temperatures beyond their normal design limits.

### SUMMARY

The present disclosure teaches a variety of electrical interconnection architectures for electrically connecting stacked prismatic battery modules in various combinations of parallel and series configurations. These interconnection architectures distribute heat sources (e.g., heat conduction through a busbar, and internal resistance heating from short circuiting) to multiple battery cells, rather than to a single adjacent cell, thereby reducing thermal excursion propagation. Examples of interconnection architectures include various combinations of overlap bus and bypass bus configurations. A two-parallel module configuration may have two serial sub-modules with cells connected in a staggered interconnection pattern. A busbar connection pattern may allow the negative inlet and positive outlet to be located on the same end of a battery module. Battery cells may be interconnected so that a parallel cell is not an adjacent cell. Various combinations of resistors and fuses may also be used to reduce overheating from short circuiting.

In a first embodiment, a battery module includes at least eight, stacked prismatic battery cells, with each cell having a positive terminal and a negative terminal arranged in a variety of different alternating patterns (architectures).

In a related embodiment, the odd-numbered battery cells 1, 3, 5, etc. have a negative-to-positive polarity direction pointing forwards from left to right, while the even-numbered cells 2, 4, 6, etc. have a reversed negative-to-positive polarity direction pointing in a backwards direction, i.e., from right to left. This “staggered alternating single-cell” pattern, i.e., −/+/−/+ . . . repeats down the left side of a battery module. A similar, but reversed, pattern repeats down the right side of the module.

In another related embodiment, a first pair of adjacent battery cells both have a negative-to-positive polarity direction pointing forwards from left to right, while the next pair of adjacent cells both have a reversed negative-to-positive polarity direction pointing backwards from right to left. This “staggered alternating two-cell” pattern, i.e., −−/++/−−/++ . . . repeats down the left side of a battery module. A similar, but reversed, pattern repeats down the right side of the module.

In another related embodiment, a first group of four adjacent battery cells have a negative-to-positive polarity direction pointing forwards from left to right, while the next group of four adjacent cells both have a reversed negative-to-positive polarity direction pointing backwards from right to left. This “staggered alternating quadruple-cell” pattern, i.e. −−−−/++++/−−−−/++++ . . . repeats down the left side of a battery module. A similar, but reversed, pattern repeats down the right side of the module.

In a related embodiment, there are two adjacent segments of battery cells, i.e., segment A and adjacent segment B. In segment A, the odd-numbered cells 1 and 3 have a negative-to-positive polarity direction pointing forwards from left to right, while the even-numbered cells 2 and 4 have a reversed negative-to-positive polarity pointing backwards from right to left. Adjacent segment B flips this pattern backwards, where the odd-numbered cells 5 and 7 now have a reversed negative-to-positive polarity direction pointing backwards from right to left, while the even-numbered cells 6 and 8 have a negative-to-positive polarity direction pointing forwards from left to right. This “staggered alternating A/B” pattern, i.e., −/+/−/+/+/−/+/− . . . repeats down the left side of a battery module. A similar, but reversed, pattern repeats down the right side of the module.

In an embodiment, the layout of battery cells in a battery module is a “staggered alternating single-cell” pattern −/+/−/+. A first C-shaped electrical “overlap” bus interconnects the first negative battery terminal to the third positive terminal, and a second, interdigitated C-shaped electrical “overlap” bus interconnects the second negative battery terminal to the fourth positive terminal, and so on down the left side of the battery module. A similar, but reversed, interconnect configuration of interdigitated, C-shaped overlap buses is used for the right side of the module.

In one embodiment, a more-negative inlet to the battery module is located at a proximal end of the module, while a more-positive outlet is located at a distal end of the module.

In another embodiment, the more-negative inlet to the battery module is located at the proximal end of the module, while the more-positive outlet is also located at the proximal (i.e., same) end of the module.

In one embodiment, the total number of battery cells, N, in a battery module is an even number.

In another embodiment, the total number of battery cells, N, in a battery module is an odd number.

In an embodiment, the layout of battery cells in a battery module is a “staggered alternating single-cell” pattern −/+/−/+. A first, C-shaped electrical “overlap” bus interconnects the first negative battery terminal to the third positive terminal; and a second, interdigitated C-shaped electrical “overlap” bus interconnects the second negative battery terminal to the fourth positive terminal, and so on down the left side of the battery module. A similar, but reversed, set of interdigitated, C-shaped overlap buses are used down the right side of the module.

In an embodiment, the layout of battery cells in a battery module is a “staggered alternating single-cell” pattern −/+/−/+. A four-pronged “overlap” bus electrically interconnects the second positive terminal to the fourth positive terminal and to the fifth negative terminal and to the seventh negative terminal; which repeats down the left side of the battery module in an interdigitated fashion. On the right side of the module, a first in-line bus interconnects the first positive terminal to the second negative terminal and to the third positive terminal and to the fourth negative terminal. This pattern of in-line buses repeats down the right side of the battery module.

In an embodiment, the layout of battery cells in a battery module is a “staggered alternating two-cell” pattern ++/−−/++/−−. A first, C-shaped “bypass” bus electrically interconnects the first positive terminal to the fourth negative terminal. A first, in-line bus interconnects the second positive terminal to the third negative terminal. These patterns repeat down the module. A first resistor may be connected across the first positive terminal and the second positive terminal. A second resistor may be connected across the third negative terminal and the fourth negative terminal. This pattern of interconnected resistors is repeated down the module.

In an embodiment, the layout of battery cells in a battery module is a “staggered alternating two-cell” pattern ++/−−/++/−−. A first, in-line bus electrically interconnects the first positive terminal to second positive terminal and to the third negative terminal and to the fourth negative terminal. These patterns repeat down the module. This example of an interconnection architecture is a “2P4S” pattern. A first fuse may be connected across the first positive terminal and the second positive terminal. A second fuse may be connected across the third negative terminal and the fourth negative terminal. This pattern of interconnected fuses is repeated down the module.

In an embodiment, the layout of battery cells in a battery module is a “staggered alternating one-cell” pattern: −/+/−/+. A first, four-pronged C-shaped overlap bus interconnects the second positive terminal to the fourth positive terminal and to the fifth negative terminal and to the seventh negative terminal, on the left side of the module. On the right side of the module is a first, in-line bus that interconnects the first positive terminal to the second negative terminal and to the third positive terminal and to the fourth negative terminal. These patterns repeat down the module.

In an embodiment, the layout of battery cells in a battery module is a “staggered alternating one-cell” pattern: −/+/−/+. A first, C-shaped overlap bus interconnects the first negative terminal to the third negative terminal. A second, interdigitated C-shaped overlap bus interconnects that second positive terminal to the fourth positive terminal. A first diagonal bus interconnects the fourth positive terminal to the adjacent fifth negative terminal. These patterns repeat down the module.

In an embodiment, the layout of battery cells is a staggered alternating quadruple cell” pattern: −−−−/++++/−−−−/++++. A first, four-pronged, non-uniformly-spaced apart, C-shaped overlap bus interconnects the second negative terminal to the fourth negative terminal and to the fifth positive terminal and to the seventh positive terminal on the left side. On the right side, a second, four-pronged, uniformly-spaced apart, C-shaped overlap bus interconnects the first positive terminal to the third positive terminal and to the fifth negative terminal and to the seventh negative terminal. These patterns repeat down the module.

In an embodiment, the layout of battery cells in a battery module is a “staggered alternating one-cell” pattern: −/+/−/+. A first, four-pronged, uniformly-spaced apart, C-shaped overlap bus interconnects the fifth positive terminal to the seventh positive terminal and to the ninth negative terminal and to the eleventh negative terminal on the left side. On the right side, a second, four-pronged, uniformly-spaced apart, C-shaped overlap bus interconnects the first positive terminal to the third positive terminal and to the fifth negative terminal and to the seventh negative terminal. These patterns repeat down the module.

In an embodiment, an electric vehicle includes: a vehicle body; a road wheel rotatably attached to the vehicle body, an electric traction drive motor rotatably attached to the road wheel, a battery tray attached to the vehicle body, and a battery module attached to the battery tray that is electrically connected to the electric traction drive motor. The battery module includes at least a first set of four stacked prismatic battery cells and a second set of four additional stacked prismatic battery cells, with a first overlap bus electrically connecting the first positive terminal to the third negative terminal, a second bus electrically connecting the second positive terminal to the fourth negative terminal; a third overlap bus electrically connecting the third positive terminal to the fifth negative terminal; a fourth overlap bus electrically connecting the fourth positive terminal to the sixth negative terminal; a fifth overlap bus electrically connecting the fifth positive terminal to the seventh negative terminal; a sixth overlap bus electrically connecting the sixth positive terminal to the eighth negative terminal; a seventh in-line bus electrically connecting the first positive terminal to the second positive terminal; and an eighth bus electrically connecting the seventh negative terminal to the eighth negative terminal. In this embodiment, the battery module has a first side and an opposing second side. The third, fourth, seventh, and eighth positive terminals are located on the first side of the battery module. Also, the first, second, fifth, and sixth positive terminals are located on the opposing second side of the battery module. Also, the first, second, fifth, and sixth negative terminals are located on the first side of the battery module, and finally the third, fourth, seventh, and eighth negative terminals are located on the opposing second side of the battery module.

### BRIEF DESCRIPTION OF THE DRAWINGS

FIG. 1 shows a perspective view of an example of an automobile vehicle with a battery tray holding a battery pack that has multiple interconnected prismatic battery modules, with each battery module comprising multiple, stacked, prismatic battery cells interconnected in various series and parallel configurations.

FIG. 2 shows a perspective exploded view of a schematic example of a battery module with multiple, stacked battery cells.

FIG. 3 shows a side elevation, exploded, cross-section view (Section A-A) of the schematic example of the battery module shown in FIG. 2.

FIG. 4 shows a front elevation cross-section view (Section B-B) of the schematic example of the battery module shown in FIG. 2.

FIG. 5 shows a top plan view of a schematic example of a battery module.

FIG. 6 shows a top plan view of a schematic example of a battery module.

FIG. 7 shows a top plan view of a schematic example of a battery module.

FIG. 8 shows a top plan view of a schematic example of a battery pack.

FIG. 9 shows a top plan view of a schematic example of a battery pack.

FIG. 10 shows a top plan view of a schematic example of a battery pack with two interconnected battery modules.

FIG. 11A shows a top plan view of a schematic example of an electrical circuit for a battery module with a cell experiencing thermal excursion.

FIG. 11B shows a top plan view of a schematic example of an electrical circuit for a battery module with a cell experiencing thermal excursion.

FIG. 12 shows a top plan view of a schematic example of a battery module.

FIG. 13 shows a top plan view of a schematic example of a battery module.

FIG. 14A shows a top plan view of a schematic example of a battery module with a thermal excursion cell.

FIG. 14B shows a top plan view of a schematic example of a battery module with a thermal excursion cell.

FIG. 15 shows a top plan view of a schematic example of a battery module.

FIG. 16 shows a top plan view of a schematic example of a battery module.

FIG. 17 shows a top plan view of a schematic example of a battery module.

FIG. 18 shows a top plan view of a schematic example of a battery module.

FIG. 19 shows a top plan view of a schematic example of a Type A battery module.

FIG. 20 shows a top plan view of a schematic example of a Type B battery module.

FIG. 21 shows a top plan view of a schematic example of a Type C battery module.

FIG. 22 shows a top plan view of a schematic example of a Type D battery module.

FIG. 23 shows a top plan view of a schematic example of a 1P4S battery architecture for a battery module.

FIG. 24 shows a top plan view of a schematic example of a 2P4S battery architecture for a battery module.

### DETAILED DESCRIPTION OF THE DISCLOSURE

The prismatic battery modules disclosed herein may be used in number of different mobile electric or hybrid-electric applications, including, but not limited to: automobiles, trucks, motorcycles, boats, submarines, aircraft, drones, spacecrafts, satellites, trains, or other mobile platforms, as well as non-mobile electric systems, such as power plants, appliances, and photovoltaic solar battery storage installations. The phrase “vehicle” is broadly defined as a moving machine, including, but not limited to: automobiles, trucks, motorcycles, boats, submarines, aircraft, drones, spacecrafts, satellites, trains, or other mobile platforms. The term “prismatic” broadly means a six-sided object with 90-degree (square) corners that may have an elongated rectangular, or square (cubical) shape. The term “battery cell” broadly includes both lithium-ion based battery chemistries and sodium-ion battery chemistries. The terms “bus”, “bussing”, and “busbar” mean the same and are interchangeable. The terms “battery cell” and “cell” mean the same and are interchangeable. The words “connect” and “interconnect” mean the same and are interchangeable. The words “connection” and “interconnection” mean the same and are interchangeable. The words “thru-hole” and “aperture” mean the same and are interchangeable.

The terms “C-shaped bus”, “C-shaped overlap bus”, “two-pronged bus”, and “two-pronged overlap bus” mean the same and are interchangeable. A “C-shaped overlap bus” may have two or four integral prongs, tabs, or fingers that extend perpendicular from a common, lengthwise bus in a comb-shaped geometry. The words “alternating” and “staggered” mean the same and are interchangeable. The word “alternating” means, among other things, “every other” (e.g., “every other battery cell”). The phrase “alternate-facing” means, among other things, “facing in the opposite direction”, or “opposite-facing” (e.g., “opposite-facing C-shaped buses”). The words “overlap” and “overlapping” mean the same and are interchangeable. The phrase “pair of interdigitated C-shaped overlap buses” means a pair of opposite-facing, offset, C-shaped overlap buses, wherein each bus has two or four prongs (tabs, fingers) that are “interlaced” or “overlapping” with the other, opposite-facing C-shaped bus. The modifier “about” means that a specified variable has a range (tolerance) of no more than +/−10% of the stated value of the specified variable.

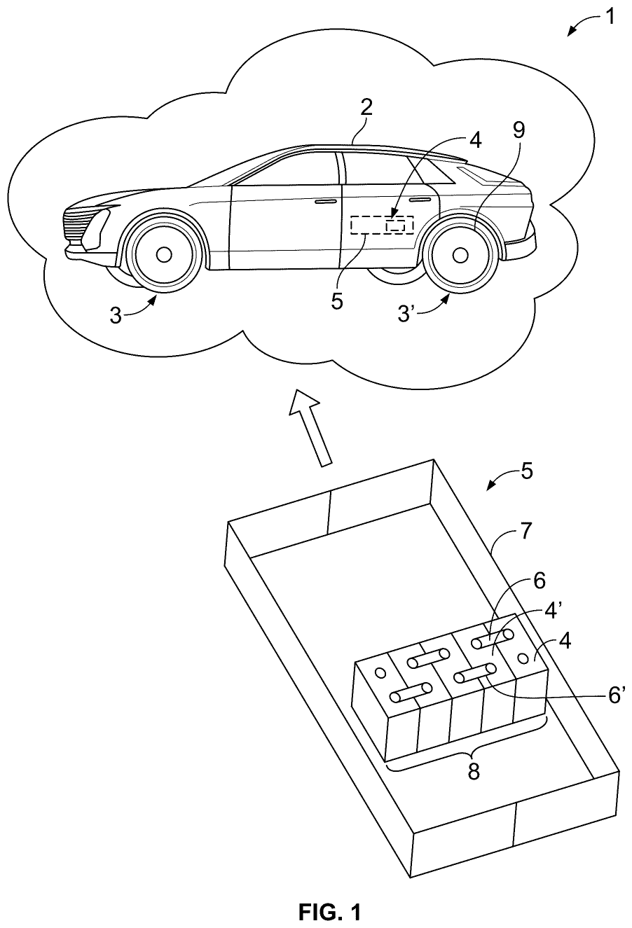

FIG. 1 shows a perspective view of an example of an automobile vehicle 1 with a vehicle body 2, two attached road wheels 3 and 3′, and a battery pack 5 comprising a battery tray 7 attached to vehicle body 2. Battery tray 7 holds a prismatic battery module 8 comprising multiple, stacked prismatic battery cells 4, 4′, etc. that are electrically interconnected with electrical buses 6, 6′, etc. in different combinations of parallel and series architectures. Battery cells 4, 4′, etc. are electrically connected to drive traction motor 9, which is rotatably attached to road wheel 3′ for driving road wheel 3′.

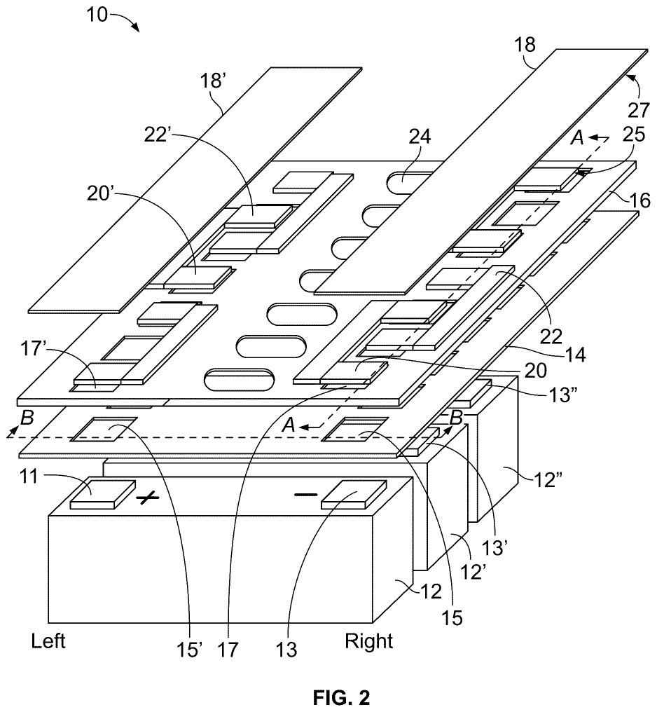

FIG. 2 shows a perspective, exploded view of a schematic example of a battery module 10 with multiple, stacked battery cells 12, 12′, 12″, etc. Battery module 10 comprises multiple stacked, 1^{st}, 2^{nd}, and 3^{rd} prismatic battery cells 12, 12′, 12″, etc., respectively. Each cell 12, 12′, 12″, etc. comprises a pair of positive cell terminals 11, 11′, 11″ and negative cell terminals 13, 13′, 13″, etc., respectively, etc. The first horizontal layer 14 that is positioned above battery cells 12, 12′, 12″, etc. is a thin, vent sheet 14 made of an electrically insulating material (e.g., mica) with multiple, pairs of thru-holes (i.e., apertures) 15 and 15′, etc. that are disposed above, and aligned vertically with, positive terminal 11 and negative terminal 13, respectively. Next, the second horizontal layer 16 that is positioned above vent sheet 14 is an Inter Connect Board (ICB) 16, which is made of an electrically insulating material (e.g., a polymer or plastic material) with multiple, pairs of thru-holes (i.e., apertures) 17 and 17′, etc. that are disposed above, and aligned vertically with, thru-holes (i.e., apertures) 15 and 15′, respectively, in vent sheet 14. Next, the third horizontal layer 25 that is positioned above ICB 16 comprises multiple, interdigitated (i.e., overlapping) pairs of right-facing and left-facing C-shaped overlap buses 20 and 20′, 22 and 22′, etc.

Referring still to FIG. 2, right-facing C-shaped overlap bus 20 is electrically connected to both the negative terminal 13 of first cell 12 and to the negative cell terminal 13″ of third battery cell 12″, in a staggered configuration. Note: negative terminal 13 protrudes vertically through vertically-aligned apertures 15 and 17 and is electrically connected to C-shaped overlap bus 20. In this embodiment, C-shaped overlap buses 20, 20′, 22, 22′, etc. have two prongs (tabs) that extend perpendicular to their respective buses (like a “comb”). Finally, the fourth horizontal layer 27 comprises a pair of lengthwise cover sheets 18 and 18′ that are positioned above the C-shaped overlap buses 20, 20′, 22, 22′, etc. that are contained in third layer 25 and electrically insulate the electrical buses 20, 20′, 22, 22′, etc. to prevent short circuiting. Cover sheets 18 and 18′ comprise an electrically insulating material (e.g., mica). Vent aperture 24 is disposed through ICB 16 and is sized appropriately to release gases that are generated when underlying vent sheet 14 is ruptured due to a thermal excursion event that pressurizes prismatic battery cell 12.

Additional details of the various examples of terminal-to-bus interconnection architectures are illustrated in the following figures.

FIG. 3 shows a side elevation, exploded, cross-section view (Section A-A) of the schematic example of battery module 10 shown previously in FIG. 2. ICB 16 has a plurality of thru-holes (apertures) 17, 17′, 17″, etc. disposed perpendicular through the thickness of ICB 16. Right-facing C-shaped overlap buses 20, 22, etc. and left-facing C-shaped overlap buses 20′, 22′, etc. are located above ICB 16, and are aligned vertically with the row of thru-holes (apertures) 17, 17′, 17″, etc. Each pair of C-shaped overlap buses 20, 20′ and 22, 22′, etc. are offset horizontally from each other in a staggered configuration.

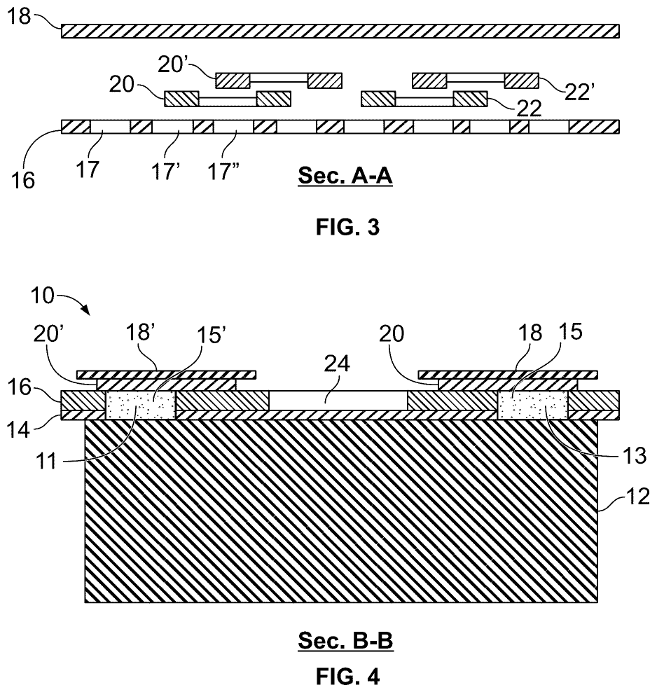

FIG. 4 shows a front, elevation cross-section view (Section B-B) of the schematic example of battery module 10 shown in FIG. 2. Battery cell 12 comprises a pair of positive and negative terminals 11 and 13, respectively. Vent sheet 14 is disposed above battery cell 12 and has a thickness that is sufficiently thin so that increased gas pressure inside of cell 12 caused by a thermal excursion event ruptures sheet 14 and vents gases upwards out through vent aperture 24, thereby preventing over-pressurization of battery cell 12 in a thermal excursion event. Next, ICB 16 is disposed above vent sheet 14, and has a pair of thru-holes (apertures) 15 and 15′ disposed through ICB 16, which are vertically aligned with cell terminals 13 and 11, respectively. Next, a pair of C-shaped overlap buses 20 and 20′ are disposed on top of ICB 16 and are vertically aligned with (and electrically connected to) underlying cell terminals 13 and 11, respectively. Finally, a pair of electrically insulating cover sheets 18 and 18′ are disposed over the pair of C-shaped overlap buses 20 and 20′, respectively.

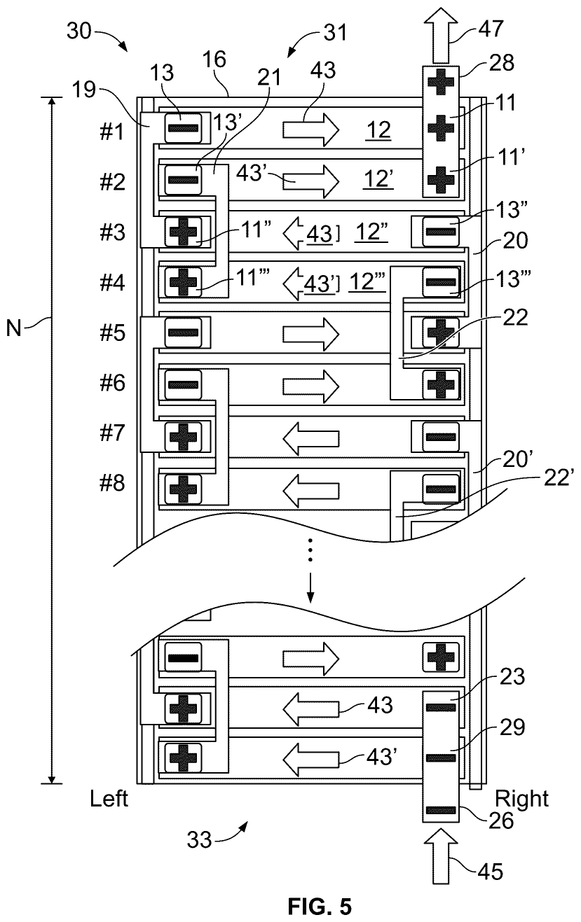

FIG. 5 shows a top plan view of a schematic example of battery module 30. Module 30 comprises at least eight prismatic battery cells 12, 12′, 12″, 12″, etc. stacked in increasing order at position #1, position #2, etc. up to position #8. The total number of stacked battery cells in module 30=N, where “N” is an even number. First cell 12 comprises a positive terminal 11 on the right side and a negative terminal 13 on the left side with a forward polarity orientation (i.e., −/+ from left to right). Likewise, adjacent second cell 12′ comprises a positive terminal 11′ and a negative terminal 13′, arranged in the same forward polarity orientation (i.e., −/+ from left to right) as does first cell 12. The next pair of cells 12″ and 12′″ both have a reversed (backward) right to left polarity orientation (i.e., −/+ from right to left) compared to the preceding pair of cells 12, 12′. This repeating pattern of pairs of cells with alternating forward/backward polarity orientations repeats down the length of module 30.

Referring still to FIG. 5, the repeating pattern of alternating pairs of positive and negative terminals down the left side of module 30 is “−/−/+/−/−/+/+ . . . ”, and so on down the length of module 30. The repeating pattern of alternating pairs positive and negative terminals down the right side of module 30 is represented by “+/+/−/−/+/+/−− . . . ”, and so on down the length of module 30. Direct current (DC) 43 flows from the negative end to the positive end of each battery cell. This embodiment is called a “2P” configuration, meaning that first current 43 flows through a first pair of two, alternating (staggered) battery cells 12 and 12″, and, simultaneously (in parallel), second current 43′ flows through a second pair of two, alternating (staggered) battery cells 12′ and 12′″ that have a reversed left to right polarity orientation, and so on throughout the rest of module 30. The two parallel currents 43 and 43′ (which have a similar magnitude) are combined by in-line outlet bus 28 to produce outlet current 47. The total number of battery cells ═N, where N equals an even number of total cells.

Referring still to FIG. 5, first, right-facing C-shaped overlap bus 19 electrically connects negative terminal 13 of first cell 12 to positive terminal 11″ of third cell 12″ in a staggered manner. Second, left-facing C-shaped overlap bus 21 electrically connects negative terminal 13′ of the second cell 12′ to positive terminal 11′″ of the fourth cell 12′″ in a staggered manner. This pattern repeats down the length of module 30. Every individual C-shaped overlap bus 19, 20, 21, 22, etc. electrically connects a negative terminal (e.g., terminal 13) of a first cell (e.g., cell 12) to a positive terminal (e.g., terminal 11″) of an alternating third cell (e.g., cell 12″) along the length of module 30, in an alternating (staggered) configuration. The two prongs of first, right-facing C-shaped overlap bus 19 are interdigitated (i.e., interleaved) with the two prongs of second, left-facing C-shaped overlap bus 21, and so on for each pair of left-facing and right-facing C-shaped overlap buses 19, 20, 21, 22, etc. Module 30 has a more-negative, in-line inlet bus 26 for inputting DC inlet current 45 at a distal (bottom) end 33 of module 30. Module 30 also has a more-positive, in-line outlet bus 28 for outputting DC outlet current 47 at a proximal (top) end 31 of module 30. More-negative in-line inlet bus 26 is electrically connected to a pair of bottom (distal) more-negative terminals 23 and 29. More-positive in-line outlet bus 28 is electrically connected to a pair of top (proximal) positive terminals 11 and 11′. The overall cell interconnection architecture used in this embodiment for module 30 is called an “Overlapping Bus” architecture.

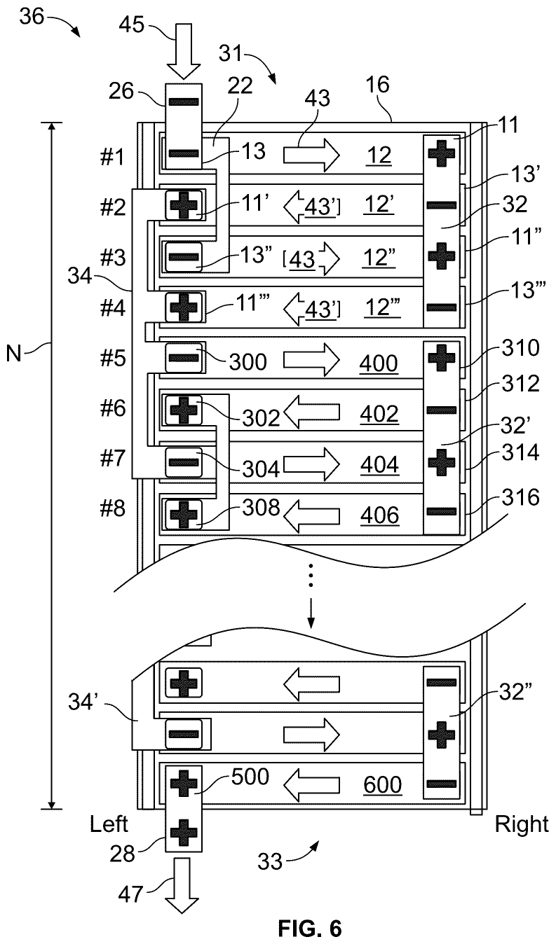

FIG. 6 shows a top plan view of a schematic example of battery module 36. Module 36 comprises at least eight prismatic battery cells 12, 12′, 12″, 12″, etc. stacked in increasing order at position #1, position #2, etc. up to position #8, and finally up to “N” stacked cells, where “N” is an even number. First cell 12 comprises a positive terminal 11 on the right side and a negative terminal 13 on the left side, arranged in a forward polarity orientation (i.e., −/+ from left to right). Likewise, adjacent second cell 12′ comprises a positive terminal 11′ on the left side and a negative terminal 13′ on the right side, arranged in a reversed (backward) polarity orientation (i.e., +/− from left to right) compared to the forward polarity orientation of first cell 12. The repeating pattern of alternating positive and negative terminals down the left side of module 36 is represented by “−/+/−/+/−/+/−/+ . . . ”, and so on down the length of module 36. The repeating pattern of alternating pairs positive and negative terminals down the right side of module 36 is represented by “+/−/+/−/+/−/+/− . . . ”, and so on down the length of module 36.

Referring still to FIG. 6, the direct current 43 (DC) flows from the negative terminals 13, 13′, 13″, etc. to the positive terminals 11, 11′, 11″ etc. of each battery cell 12, 12′, 12″, etc., respectively. The negative terminal 13 of first cell 12 is electrically connected to the negative terminal 13′ of the non-adjacent third cell 12″ via first left-facing C-shaped overlap bus 22. The positive terminal 11′ of second cell 12′ is connected to the positive terminal 11′″ of fourth cell 12′″ and to the negative terminal 300 of fifth cell 400 and to the negative terminal 304 of seventh cell 404 via first, right-facing four-pronged (i.e., four-fingered) C-shaped overlap bus 34. On the right-hand side of module 36, first in-line bus 32 interconnects positive terminal 11 of first cell 12 to negative terminal 13′ of second cell 12′ to positive terminal 11″ of third cell 12″ to negative terminal 13′″ of fourth cell 12″. Likewise, on the right-hand side of module 36, second in-line bus 32′ interconnects positive terminal 310 of fifth cell 400 to negative terminal 312 of sixth cell 402 to positive terminal 314 of seventh cell 404 to negative terminal 316 of eighth cell 406. The total number of battery cells ═N in module 36, where N is an even number.

Referring still to FIG. 6, module 36 has a negative inlet bus 26 for inputting DC inlet current 45 at a proximal (top) end 31 of module 36, and a positive outlet bus 28 for outputting DC outlet current 47 at a distal (bottom) end 33 of module 36. Negative inlet bus 26 is electrically connected to negative terminal 13 of first cell 12, and positive outlet bus 28 is electrically connected to positive terminal 500 of the last cell 600.

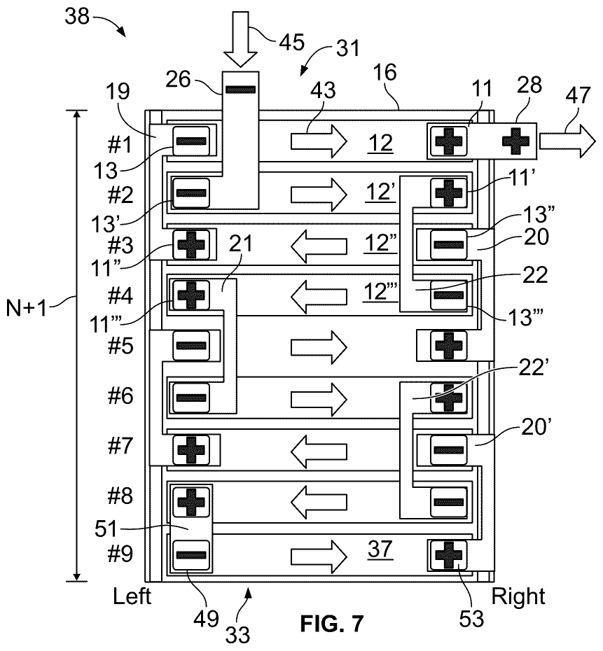

FIG. 7 shows a top plan view of a schematic example of battery module 38. The configuration of battery cells 12, 12′, 12″, 12″, etc. is identical to the example of battery module 30 previously illustrated in FIG. 5, with the exception being that one extra battery cell 37 (i.e., a ninth cell) has been added at the distal end 33 of module 38. DC inlet current 45 enters the proximal end 31 of module 38 through inlet bus 26, which is electrically connected to negative terminal 13′ of the second cell 12′. Ninth cell 37 comprises a negative terminal 49 and a positive terminal 53. The negative terminal 49 of cell 37 is electrically connected to the positive terminal of the eighth cell with electrical bus 51. This allows DC current 43 to cross-over from the left side to the right side of ninth cell 37 at the distal end 33 of module 38 and then subsequently returns back up to the proximal end 31 of module 38. Outlet DC current 47 leaves module 38 through outlet bus 28, which is electrically connected to positive terminal 11 of the first cell 12. In this embodiment, the total number of battery cells in module 38 equals an odd number (=N+1), where N is an even number. Both the inlet current 45 and the outlet current 47 are located at the same proximal (top) end 31 of module 38.

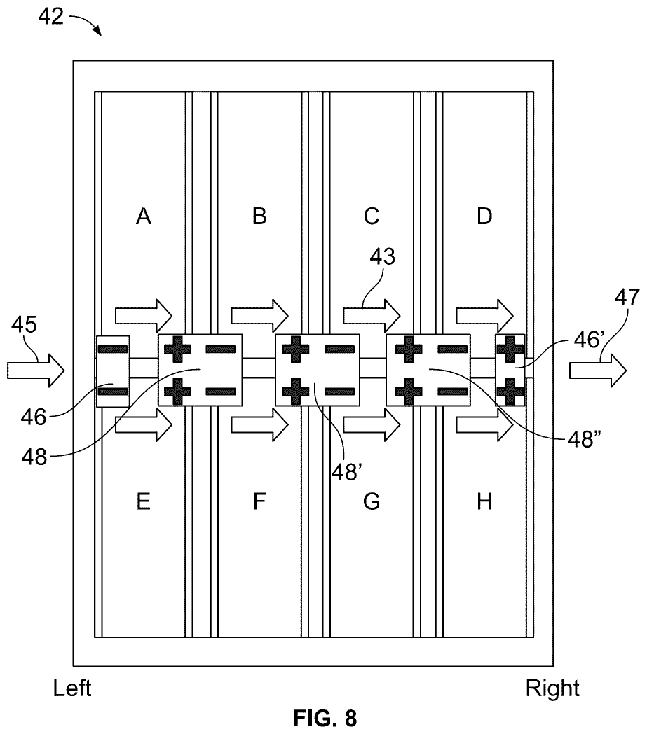

FIG. 8 shows a top plan view of a schematic example of a battery pack 42 comprising eight battery modules labelled A, B, C, D, E, F, G, and H. Each individual module A, B, C, etc. has a more-negative input bus 46 and a more-positive output bus 48 located at the same end of each module. The eight interconnected modules A, B, C, etc. are electrically connected in a “2P4S” parallel/serial configuration, meaning that there are two modules connected in parallel and four modules connected in series. Specifically, the two negative terminals of modules A and E are connected together by first bus 46. Next, the two positive terminals of modules A and E are connected together (along with the two negative terminals of modules B and F) by second bus 48. Likewise, the two positive terminals of modules B and F are connected (along with the two negative terminals of modules C and G) by third bus 48′. Likewise, the two positive terminals of modules C and G are connected (along with the two negative terminals of modules D and H) by fourth bus 48″. Finally, the two positive terminals of modules D and H are connected by fifth bus 46′. DC inlet current 45 flows from left to right in FIG. 8 through module 42, exiting with outlet current 47.

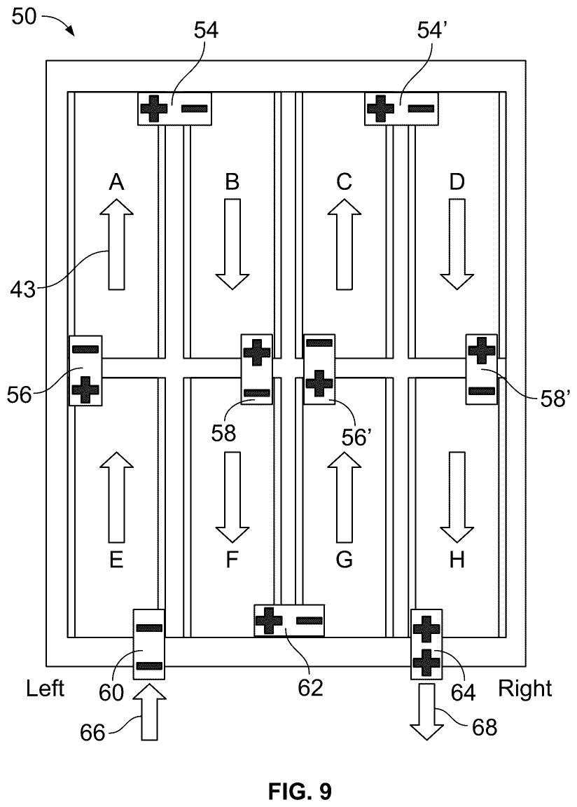

FIG. 9 shows a top plan view of a schematic example of a battery pack 50 comprising eight battery modules labelled A, B, C, D, E, F, G, and H. Module E has a more-negative input bus 60, etc. and a more-positive output bus 56, etc. located at opposite corners (i.e., diagonally) of module E, and so on for the remaining modules. The eight interconnected modules A, B, C, etc. are electrically connected in a “1P8S” serial configuration, meaning that there is one parallel string (i.e., “1P) and eight modules A, B, C, etc. that are connected in series (i.e., “8S”) to make an “1P8S” architecture. Specifically, the positive terminal of module E and the negative terminal of module A are connected by first busbar 56. Likewise, the positive terminal of module A and the negative terminal of module B are connected by second busbar 54. Likewise, the positive terminal of module B and the negative terminal of module F are connected together by third busbar 58. Likewise, the positive terminal of module F and the negative terminal of module G are connected by fourth busbar 62. Likewise, the positive terminal of module G and the negative terminal of module C are connected by fifth busbar 56′. Likewise, the positive terminal of module C and the negative terminal of module D are connected by sixth busbar 54′. Finally, the positive terminal of module D and the negative terminal of module H are connected together by seventh busbar 58′. DC inlet current 66 flows into module E through inlet bus 60 and exits module H through outlet bus 64 with outlet current 68.

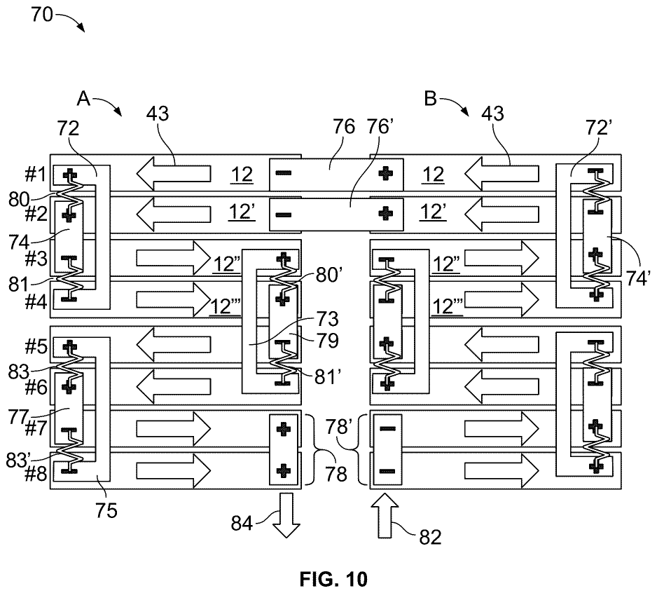

FIG. 10 shows a top plan view of a schematic example of a battery pack 70 comprising two interconnected battery modules A and B. Each module A and B comprises eight stacked prismatic battery cells 12, 12′, 12″, 12′″ etc. numbered #1, #2, #3, #4, and so on. The cell interconnection architecture used for each module A and B is called a “Bypass Bus” architecture. The term “bypass bus” means that cell #1 is connected to cell #4, bypassing the two cells #2 and #3 that are located in-between the first and fourth cells. In module A, the positive terminal of first cell 12 is electrically connected to the negative terminal of fourth cell 12′″ via left-facing C-shaped bypass bus 72. Likewise, the positive terminal of third cell 12″ is electrically connected to the negative terminal of the sixth cell via right-facing C-shaped bypass bus 73. Additionally, the positive terminal of second cell 12′ is electrically connected to negative terminal of third cell 12″ via first in-line bus 74. Likewise, the positive terminal of fourth cell 12′″ is electrically connected to negative terminal of the fifth cell via second in-line bus 79. The interconnection architecture of each individual module A and B is a “2P4S” parallel/series architecture. Finally, module A is connected in series with module B via two, parallel electrical buses 76 and 76′.

Referring still to FIG. 10, module B has the same interconnection architecture as module A. DC inlet current 82 flows into inlet bus 78′, then through module B, then through parallel electrical buses 76 and 76′, then through module B, and finally out through outlet bus 78 as outlet current 84.

Referring still to FIG. 10, each module A and B may have six resistors apiece. In module A, resistor 80 is connected across the positive terminal of first cell 12 and the positive terminal of adjacent second cell 12′. Resistor 81 is connected across the negative terminal of third cell 12″ and the negative terminal of adjacent fourth cell 12″. Resistor 80′ is connected across the positive terminal of third cell 12″ and the positive terminal of adjacent fourth cell 12′″. Resistor 81′ is connected across the negative terminal of the fifth cell and the negative terminal of the adjacent sixth cell. Resistor 83 is connected across the positive terminal of the fifth cell and the positive terminal of the sixth cell. Resistor 83′ is connected across the negative terminal of the seventh cell and the negative terminal of the adjacent eighth cell. Likewise, there are six resistors in module B that are located at similar positions as in module A.

Referring still to FIG. 10, when considering a thermal excursion event, the resistance of resistors 80, 80′, 81, 81′, etc. may be sized large enough to restrict short circuit current (and resistive heating) to a negligible level. When considering normal operation, the resistance may be sized small enough to allow cell balancing (e.g., D State of Charge (SOC) and Cell-to-cell balancing criteria).

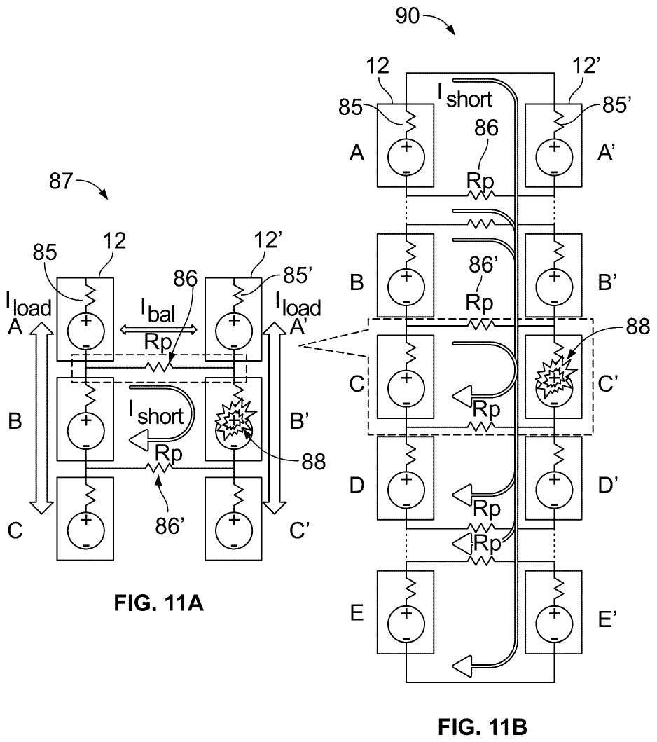

FIG. 11A shows a top plan view of an example of a schematic electrical circuit for battery module 87 with a cell 88 experiencing a thermal excursion event and causing a short circuit, Iₛₕₒᵣₜ. Cell 12 has an internal (inherent) resistance 85, and cell 12′ has an internal (inherent) resistance 85′. Resistors 86 and 86′ are disposed in-between (across) first battery cell string A-B-C and second battery cell string A′-B′-C′. Resistors 86 and 86′, each with a resistance=Rₚ, help to protect the remaining battery cells from overheating due to internal resistance heating from short circuit, Iₛₕₒᵣₜ, by reducing the magnitude of short circuit, Iₛₕₒᵣₜ.

Referring still to FIG. 11A, the size of resistance, Rp, of resistors 86 and 86′ may be optimized based on various factors, including: chemistry, capacity, (Direct Current Internal Resistance (DCIR), electrical parallel-series architecture, etc. When considering a thermal excursion event, Rₚ may be sized large enough to restrict short circuit current (and resistive heating) to a negligible level. When considering normal operation, Rₚ may be sized small enough to allow cell balancing (e.g., delta State of Charge (SOC) and Cell-to-cell balancing criteria).

FIG. 11B shows a top plan view of an example of a schematic electrical circuit for battery module 90 with a cell 88 experiencing a thermal excursion event and causing a short circuit, Iₛₕₒᵣₜ. Cell 12 has an internal (inherent) resistance 85, and cell 12′ has an internal (inherent) resistance 85′. Resistors 86, 86′, etc. are disposed in-between (across) first battery cell string A-B-C-D-E and second battery cell string A′-B′-C′-D′-E′.

Referring still to FIG. 11B, resistors 86, 86′, etc. with a resistance=Rₚ, help to protect the remaining battery cells from overheating due to internal resistance heating from short circuit, Iₛₕₒᵣₜ, by reducing the magnitude of short circuit, Iₛₕₒᵣₜ. When considering a thermal excursion event, Rₚ may be sized large enough to restrict short circuit current (and resistive heating) to a negligible level. When considering normal operation, Rₚ may be sized small enough to allow cell balancing (e.g., Δ State of Charge (SOC) and Cell-to-cell balancing criteria).

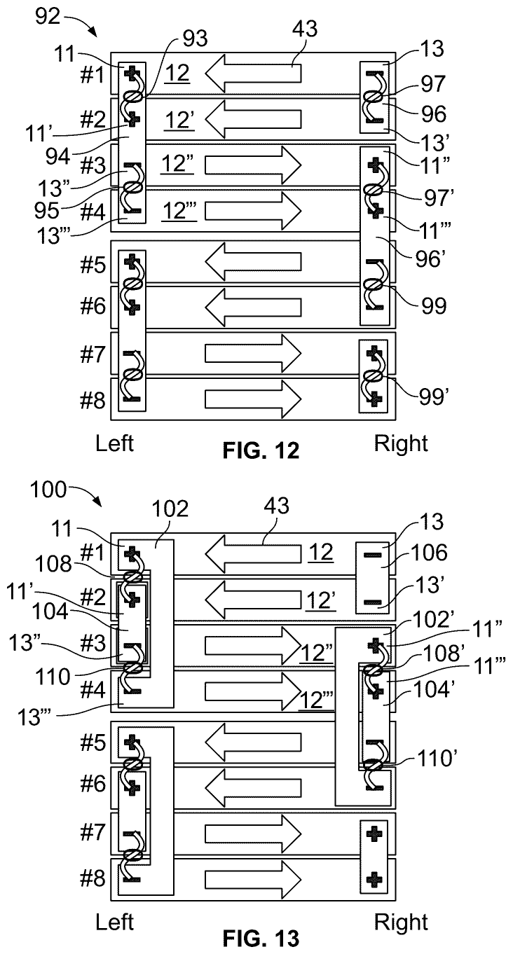

FIG. 12 shows a top plan view of a schematic example of battery module 92. Module 92 comprises eight stacked prismatic battery cells 12, 12′, 12″, 12′″, etc., numbered #1, #2, etc. to #8. First cell 12 comprises a positive terminal 11 on the left side and a negative terminal 13 on the right side. Likewise, adjacent second cell 12′ comprises a positive terminal 11′ on the left side and a negative terminal 13′ on the right side. Third cell 12″ comprises a negative terminal 13′ on the left side and a positive terminal 11″ on the right side. Likewise, adjacent fourth cell 12′″ comprises a negative terminal 13′″ on the left side and a positive terminal 11′″ on the right side. The repeating pattern of alternating pairs of two positive and two negative terminals down the left side of module 92 is represented by “+/+/−/−/+/+/−/− . . . ”, and so on down the length of module 92. The repeating pattern of alternating pairs of two negative and two positive terminals down the right side of module 92 is represented by “−/−/+/+/−/−/+/+ . . . ”, and so on down the length of module 92.

Referring still to FIG. 12, positive terminal 11 of first cell 12 is electrically connected to positive terminal 11′ of second cell 12′ and to negative terminal 13′ of third cell 12″ and to negative terminal 13′″ of fourth cell 12′″ via first in-line bus 94. In a similar fashion, positive terminal 11″ of third cell 12″ is electrically connected to positive terminal 11′″ of fourth cell 12″ and to the negative terminal of the fifth cell and to negative terminal of the sixth cell via second in-line bus 96′. The DC current 43 flows from the negative cell terminal to the positive cell terminal of each individual battery cell. This repeating pattern is called a “2P4S” architecture (two parallel groups and four series groups).

Referring still to FIG. 12, in this embodiment, a first fuse 93 is disposed in-between positive terminal 11 of first cell 12 and positive terminal 11′ of second cell 12′. Second fuse 95 is disposed in-between negative terminal 13″ of third cell 12″ and negative terminal 13′″ of fourth cell 12″. Third fuse 97 is disposed in-between negative terminal 13 of first cell 12 and negative terminal 13′ of second cell 12′. Fourth fuse 97′ is disposed in-between positive terminal 11″ of third cell 12″ and positive terminal 11′″ of fourth cell 12″. Fifth fuse 99 is disposed in-between the negative terminal of the fifth cell and the negative terminal of the sixth cell. Sixth fuse 99′ is disposed in-between the positive terminal of the seventh cell and the positive terminal of the eighth cell.

Referring still to FIG. 12, when considering a thermal excursion event, the strength of each fuse 93, 95, 97, 97′, 99, and 99′ may be sized small enough to restrict short circuit current (and resistive heating) to a negligible level. When considering normal operation, the strength of each fuse 93, 95, 97, 97′, 99, and 99′ may be sized large enough to allow cell balancing (e.g., A State of Charge (SOC) and Cell-to-cell balancing criteria), as well as ensuring no nuisance opening of the fuse.

FIG. 13 shows a top plan view of a schematic example of battery module 100. Module 100 comprises eight stacked prismatic battery cells 12, 12′, 12″, 12″, etc., numbered #1, #2, etc. to #8. First cell 12 comprises a positive terminal 11 on the left side and a negative terminal 13 on the right side. Likewise, adjacent second cell 12′ comprises a positive terminal 11′ on the left side and a negative terminal 13′ on the right side. Third cell 12″ comprises a negative terminal 13″ on the left side and a positive terminal 11″ on the right side. Likewise, adjacent fourth cell 12′″ comprises a negative terminal 13′″ on the left side and a positive terminal 11′″ on the right side. The repeating pattern of alternating pairs of two positive and pairs of two negative terminals on the left side of module 100 is represented by “+/+/−/−/+/+/−/− . . . ”, and so on down the length of module 100. The repeating pattern of alternating pairs of two negative and pairs of two positive terminals on the right side of module 100 is represented by “−/−/+/+/−/−/+/+ . . . ”, and so on down the length of module 100.

Referring still to FIG. 13, on the left side of module 100, positive terminal 11 of first cell 12 is electrically connected to negative terminal 13′″ of fourth cell 12′″ via left-facing C-shaped bypass bus 102. Positive terminal 11′ of second cell 12′ is electrically connected to negative terminal 13″ of third cell 12″ via first in-line bus 104. On the right side of module 100, negative terminal 13 of first cell 12 is electrically connected to negative terminal 13′ of second cell 12′ via second in-line bus 106. Positive terminal 11″ of third cell 12″ is electrically connected to the negative terminal of the sixth cell via right-facing C-shaped bypass bus 102′. Positive terminal 11′″ of fourth cell 12′″ is electrically connected to the negative terminal of the fifth cell via second in-line bus 104′. The cell interconnection architecture used for module 100 is called a “Bypass Bus” architecture. The term “bypass bus” means that cell #1 is connected to cell #4, bypassing the two cells #2 and #3 that are located in-between the first and fourth cells.

Referring still to FIG. 13, in this embodiment, a first fuse 108 is disposed in-between positive terminal 11 of first cell 12 and positive terminal 11′ of second cell 12′. Second fuse 110 is disposed in-between negative terminal 13″ of third cell 12″ and negative terminal 13′″ of fourth cell 12″. Third fuse 108′ is disposed in-between positive terminal 11″ of third cell 12″ and positive terminal 11′″ of fourth cell 12″. Fourth fuse 110′ is disposed in-between the negative terminal of the fifth cell and the negative terminal of the sixth cell.

Referring still to FIG. 13, when considering a thermal excursion event, the strength of each fuse 108, 108′, 110, 110′ may be sized small enough to restrict short circuit current (and resistive heating) to a negligible level. When considering normal operation, the strength of each fuse 108, 108′, 110, 110′ may be sized large enough to allow cell balancing (e.g., A State of Charge (SOC) and Cell-to-cell balancing criteria), as well as ensuring no nuisance opening of the fuse.

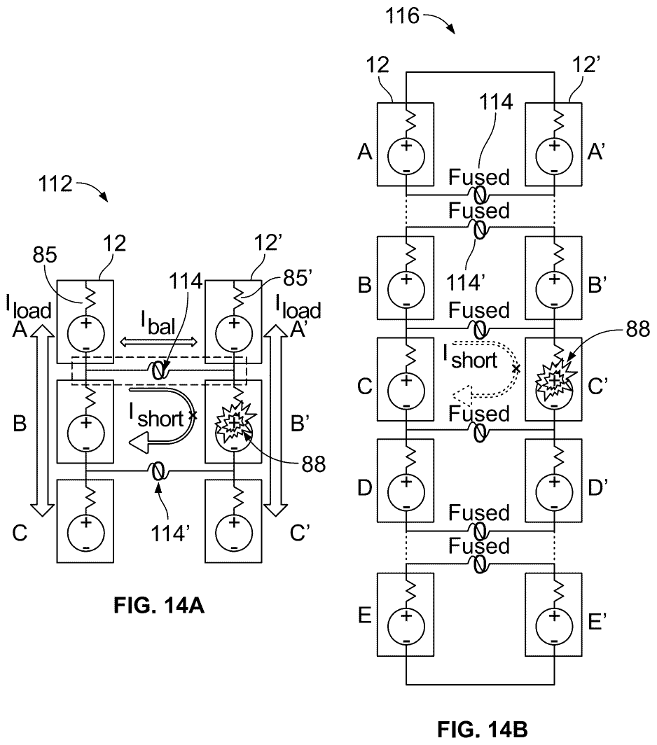

FIG. 14A shows a top plan view of a schematic example of an electrical circuit for battery module 112 with a cell 88 experiencing a thermal excursion event and causing a short circuit, Iₛₕₒᵣₜ. Fuses 114 and 114′ are disposed in-between (across) first battery cell string A-B-C and second battery cell string A′-B′-C′. Fuses 114 and 114′ help to protect the remaining battery cells from overheating from internal resistance heating due to short circuit, Iₛₕₒᵣₜ, by reducing the magnitude of short circuit, Iₛₕₒᵣₜ.

Referring still to FIG. 14A, when considering a thermal excursion event, the strength of each fuse 114, 114′ may be sized small enough to restrict short circuit current (and resistive heating) to a negligible level. When considering normal operation, the strength of each fuse may be sized large enough to allow cell balancing (e.g., A State of Charge (SOC) and Cell-to-cell balancing criteria), as well as ensuring no nuisance opening of the fuse.

FIG. 14B shows a top plan view of a schematic example of an electrical circuit for battery module 116 with a cell 88 experiencing a thermal excursion event and causing a short circuit, Iₛₕₒᵣₜ. Fuses 114, 114′, etc. are disposed across first battery cell string A-B-C-D-E and second battery cell string A′-B′-C′-D′-E′. Fuses 114, 114′, etc. help to protect the remaining battery cells from overheating from internal resistance heating due to short circuit, Iₛₕₒᵣₜ, by reducing the magnitude of short circuit, Iₛₕₒᵣₜ.

Referring still to FIG. 14B, when considering a thermal excursion event, the strength of each fuse 114, 114′, etc. may be sized small enough to restrict short circuit current (and resistive heating) to a negligible level. When considering normal operation, the strength of each fuse may be sized large enough to allow cell balancing (e.g., A State of Charge (SOC) and Cell-to-cell balancing criteria), as well as ensuring no nuisance opening of the fuse.

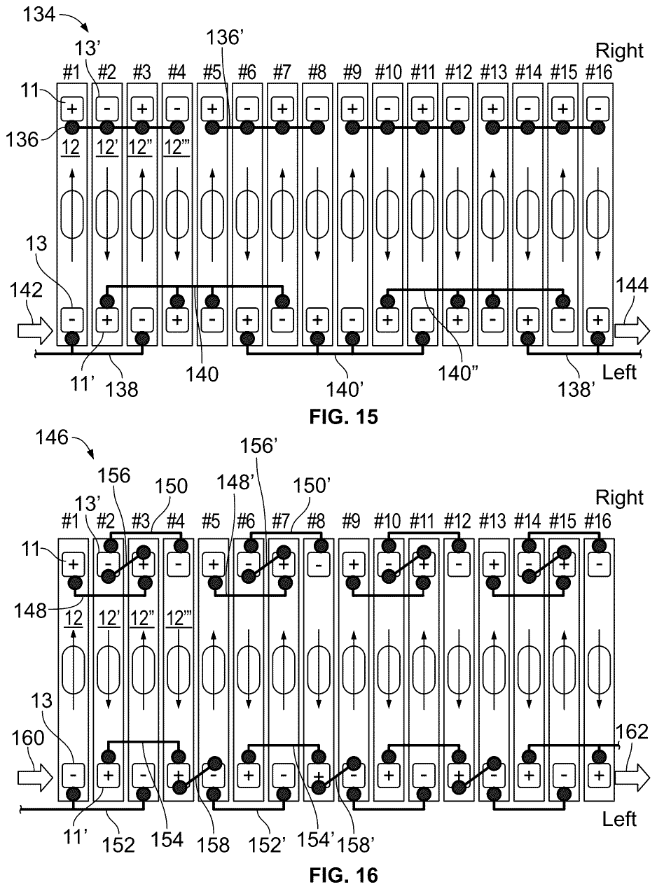

FIG. 15 shows a top plan view of a schematic example of a battery module 134. Module 134 comprises sixteen stacked prismatic battery cells 12, 12′, 12″, 12″, etc., numbered in sequential order from #1, #2, etc. to #16. First cell 12 comprises a positive terminal 11 on the right side and a negative terminal 13 on the left side. Adjacent second cell 12′ comprises a reverse polarity orientation comprising a positive terminal 11′ on the left side and a negative terminal 13′ on the right side. This repeating pattern of alternating pairs of negative and positive terminals down the left side of module 134 is represented by “−/+/−/−/+/−/+ . . . ”, and so on down the length of module 134. The repeating pattern of alternating pairs of positive and negative terminals down the right side of module 134 is represented by “+/−/+/−/+/−/+/− . . . ”, and so on down the length of module 134.

Referring still to FIG. 15, on the left side of module 134, inlet current 142 enters the negative terminal 13 of first cell 12, which is electrically connected to the negative terminal of third cell 12″ via first four-pronged overlap bus 138. Next, the positive terminal of second cell 12′ is electrically connected to the positive terminal of the fourth cell 12″ and to the negative terminal of the fifth cell and to the negative terminal of the sixth cell via an opposite-facing, second four-pronged overlap bus 140, and so on down the left side of module 134 towards outlet current 144.

Referring still to FIG. 15, on the right side of module 134, the positive terminal 11 of first cell 12 is electrically connected to the negative terminal of second cell 12′ and to the positive terminal of third cell 12″ and to the negative terminal of fourth cell 12′″ via a first in-line electrical bus 136, and so on down the right side of module 134. Likewise, second in-line bus 136′ connects the next four cells down the length of module 134, and so on to the distal end of module 134. The interconnection architecture illustrated in FIG. 15 comprises one straight (in-line) busbar 136, 136′, etc. connecting four adjacent cells, and one longer busbar 138, 140, 140′, 140″, 138′, etc. connecting two adjacent cells and two alternative cells.

FIG. 16 shows a top plan view of a schematic example of battery module 146. Module 146 comprises sixteen stacked prismatic battery cells 12, 12′, 12″, 12′″, etc., numbered in sequential order from #1, #2, etc. to #16. First cell 12 comprises a positive terminal 11 on the right side and a negative terminal 13 on the left side. Adjacent second cell 12′ comprises a reverse polarity orientation comprising a positive terminal 11′ on the left side and a negative terminal 13′ on the right side. The repeating pattern of alternating pairs of negative and positive terminals down the left side of module 146 is represented by “−/+/−/+/−/+/−/+ . . . ”, and so on down the length of module 146. The repeating pattern of alternating pairs of positive and negative terminals down the right side of module 146 is represented by “+/−/+/−/+/−/+/− . . . ”, and so on down the length of module 146.

Referring still to FIG. 16, on the left side of module 146, inlet current 160 enters the negative terminal 13 of first cell 12, which is electrically connected to the negative terminal of the third cell 12″ via first C-shaped overlap bus 152. Next, the positive terminal of the second cell 12′ is electrically connected to the positive terminal of the fourth cell 12″ via a second, opposite-facing C-shaped overlap bus 154. A first diagonal busbar 158 electrically connects the positive terminal of the fourth cell to the negative terminal of the adjacent fifth cell. A second diagonal busbar 158′ electrically connects the positive terminal of the eighth cell to the negative terminal of the adjacent ninth cell, and so on down the length of module 146. This left-side repeating pattern of alternate-facing C-shaped overlap buses 152, 154, 152′, and 154′, etc. and diagonal busbars 158, 158′, etc. is repeated down the left side of module 146 towards outlet current 162.

Referring still to FIG. 16, on the right side of module 146, the positive terminal 11 of the first cell 12 is electrically connected to the positive terminal of the third cell via a third C-shaped overlap bus 148. Next, the negative terminal of the second cell is electrically connected to the negative terminal of the fourth cell via a fourth, opposite-facing C-shaped overlap bus 150. A third diagonal busbar 156 electrically connects the negative terminal of the second cell to the positive terminal of the adjacent third cell. A fourth diagonal busbar 156′ electrically connects the negative terminal of the sixth cell to the positive terminal of the adjacent seventh cell, and so on down the length of module 146. This right-side repeating pattern of alternate-facing C-shaped overlap buses 148, 150, 148′, 150′, etc. and diagonal busbars 156, 156′, etc. is repeated down the right side of module 146. The interconnection architecture illustrated in FIG. 16 comprises one shorter busbar connecting two adjacent cells, and one longer busbar connecting two alternative (staggered) cells.

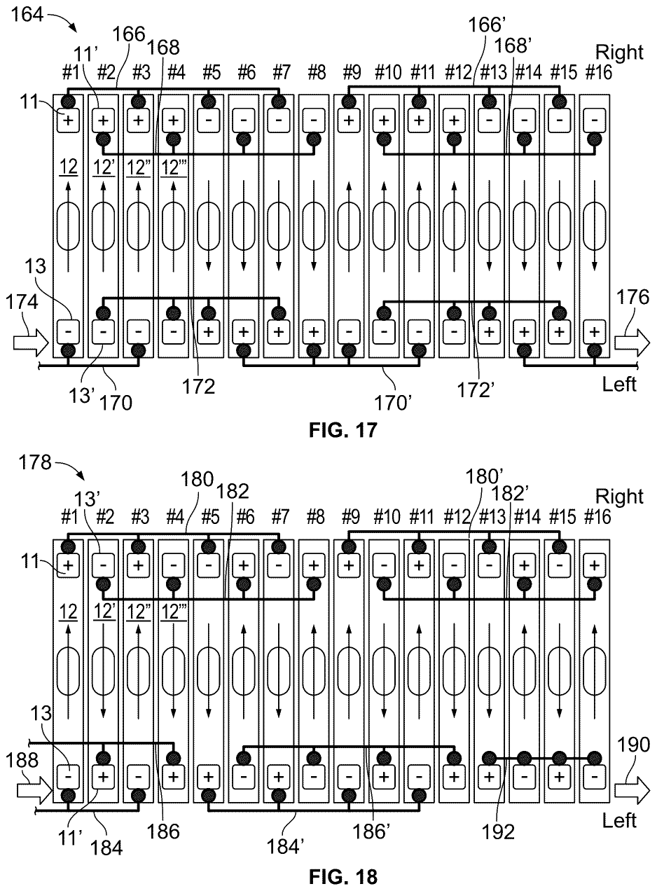

FIG. 17 shows a top plan view of a schematic example of battery module 164. Module 164 comprises sixteen stacked prismatic battery cells 12, 12′, 12″, 12″, etc., numbered in sequential order from #1, #2, etc. to #16. First cell 12 comprises a positive terminal 11 on the right side and a negative terminal 13 on the left side. Likewise, adjacent second cell 12′ comprises a positive terminal 11′ on the right side and a negative terminal 13′ on the left side, and so one for the next two adjacent third and four cells 12″, 12″, respectively. The repeating pattern of alternating groups of four negative terminals, then four positive terminals, etc. down the left side of module 164 is represented by “−/−/−/−/+/+/+/+ . . . ”, and so on down the length of module 164. The repeating pattern of alternating groups of four positive terminals, then four negative terminals on the right side of module 164 is represented by “+/+/+/+/−/−/−/− . . . ”, and so on down the length of module 164.

Referring still to FIG. 17, on the left side of module 164, inlet current 174 enters the negative terminal 13 of first cell 12, which is electrically connected to the negative terminal of the third cell 12″ via first, non-uniformly spaced apart, four-pronged overlap bus 170. Next, the negative terminal of the second cell is electrically connected to the negative terminal of the fourth cell and then to the positive terminal of the fifth cell and finally to the positive terminal of the seventh cell via a second, alternate-facing, non-uniformly spaced apart, four-pronged overlap bus 172. Next, the positive terminal of the sixth cell is electrically connected to the positive terminal of the eighth cell and then to the negative terminal of the ninth cell and finally to the negative terminal of the eleventh cell via a third, non-uniformly spaced apart, four-pronged overlap bus 170′. This left-side repeating pattern of alternate-facing, non-uniformly spaced apart, four-pronged buses 172, 170′, 172′, etc. is repeated down the left side of module 164 towards outlet current 176.

Referring still to FIG. 17, on the right side of module 164, the positive terminal 11 of the first cell 12 is electrically connected to the positive terminal of the third cell and to the negative terminal of the fifth cell and then to the negative terminal of the seventh cell via a fourth, uniformly-spaced apart, four-pronged overlap bus 166. Next, the positive terminal of the second cell is electrically connected to the positive terminal of the fourth cell and then to the negative terminal of the sixth cell and finally to the negative terminal of the eighth cell via a fifth, alternate-facing, uniformly-spaced apart, four-pronged overlap bus 168. This right-side repeating pattern of alternate-facing, uniformly-spaced apart four-pronged buses 166, 168, 166′, 168′, etc. is repeated down the right side of module 164. The interconnection architecture illustrated in FIG. 17 comprises one type of uniformly-spaced apart busbar connecting four alternative (staggered) cells, and another type non-uniformly spaced apart busbar connecting two adjacent cells and two alternative (staggered) cells.

FIG. 18 shows a top plan view of a schematic example of battery module 178. Module 178 comprises sixteen stacked prismatic battery cells 12, 12′, 12″, 12″, etc., numbered in sequential order from #1, #2, etc. to #16. First cell 12 comprises a positive terminal 11 on the right side and a negative terminal 13 on the left side. Likewise, adjacent second cell 12′ comprises a reverse polarity orientation comprising positive terminal 11′ on the left side and a negative terminal 13′ on the right side. The repeating pattern of alternating pairs of negative terminals and positive terminals down the left side of module 178 is represented by “−/+/−/+/−/+/−/+ . . . ”, and so on down the length of module 178. The repeating pattern of alternating pairs of positive terminals and negative terminals down the right side of module 178 is represented by “+/−/+/−/+/−/+/− . . . ”, and so on down the length of module 178.

Referring still to FIG. 18, on the left side of module 178, inlet current 188 enters negative terminal 13 of first cell 12, which is electrically connected to the negative terminal of the alternative (staggered) third cell 12″ via first four-pronged, uniformly-spaced apart, overlap bus 184. Next, the positive terminal of the second cell is electrically connected to the positive terminal of the fourth cell via a second, alternate-facing, uniformly-spaced apart, four-pronged overlap bus 186. Next, the positive terminal of the fifth cell is electrically connected to the positive terminal of the seventh cell and then to the negative terminal of the ninth cell and finally to the negative terminal of the eleventh cell via a third, four-pronged, uniformly-spaced apart, overlap bus 184′. Next, the negative terminal of the sixth cell is electrically connected to the negative terminal of the eighth cell and then to the positive terminal of the tenth cell and finally to the positive terminal of the twelfth cell via a fourth, alternate-facing, uniformly-spaced apart, four-pronged overlap bus 186′. This left-side repeating pattern of alternate-facing uniformly-spaced apart, four-pronged overlap buses 184, 186, 184′, 186′, etc. is repeated down the left side of module 178 towards outlet current 190. At the outlet end of module 178, an in-line bus 192 interconnects the positive terminal of the thirteenth cell to the negative terminal of the fourteenth cell and to the positive terminal of the fifteenth cell and to the negative terminal of the sixteenth cell, before exiting module 178 via outlet current 190.

Referring still to FIG. 18, on the right side of module 178, the positive terminal 11 of the first cell 12 is electrically connected to the positive terminal of the third cell and to the negative terminal of the fifth cell and then to the negative terminal of the seventh cell via a fifth, uniformly-spaced apart, four-pronged overlap bus 180. Next, the negative terminal of the second cell is electrically connected to the negative terminal of the fourth cell and then to the positive terminal of the sixth cell and finally to the positive terminal of the eighth cell via a sixth, alternate-facing, uniformly-spaced apart, four-pronged overlap bus 182. This right-side repeating pattern of alternate-facing uniformly-spaced apart, four-pronged overlap buses 180, 182, 180′, 182′, etc. is repeated down the right side of module 178. The interconnection architecture illustrated in FIG. 18 comprises one type of alternate-facing, uniformly-spaced apart, four-pronged overlap bus connecting four alternative (staggered) cells.

FIG. 19 shows a top plan view of a schematic example of a Type A battery module. Battery module A comprises a repeating sub-unit comprising four stacked prismatic battery cells 200, 202, 204, and 206 that are sequentially numbered #1, #2, #3, and #4. The repeating pattern of alternating pairs of two adjacent positive terminals 201 and 203, and two adjacent negative terminals 205 and 207 on the left side of module A is represented by: “+/+/−/−”. The repeating pattern of alternating pairs of two negative adjacent terminals 209 and 211 and two positive adjacent terminals 213 and 215 on the right side of module A is represented by “−/−/+/+”.

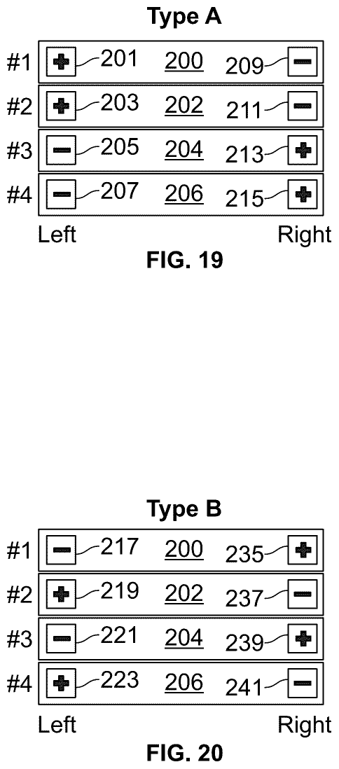

FIG. 20 shows a top plan view of a schematic example of a Type B battery module. Battery module B comprises a repeating sub-unit comprising four stacked prismatic battery cells 200, 202, 204, and 206 that are sequentially numbered #1, #2, #3, and #4. The repeating pattern of alternating negative terminals 217, 221 and positive terminals 219, 223 on the left side of module B is represented by “−/+/−/+”. The repeating pattern of alternating positive terminals 235, 239 and negative terminals 237, 241 on the right side of module B is represented by “+/−/+/−”.

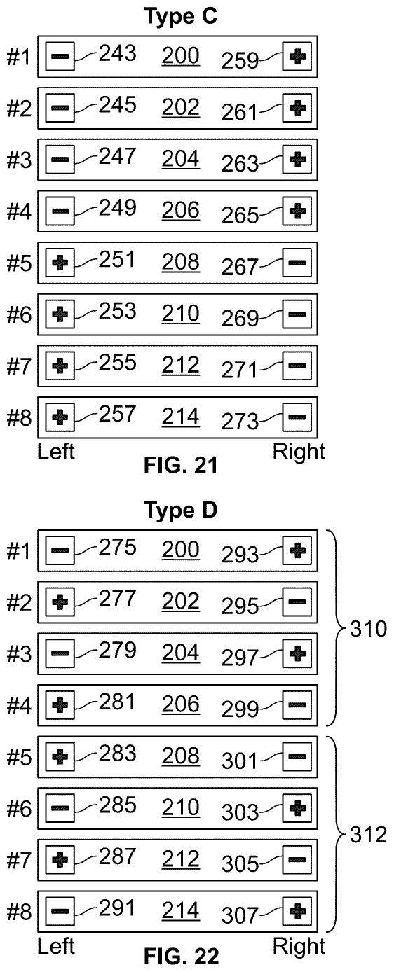

FIG. 21 shows a top plan view of a schematic example of a Type C battery module. Battery module C comprises a repeating sub-unit comprising eight stacked prismatic battery cells 200, 202, 204, etc. through 218 that are sequentially numbered #1, #2, #3, etc. through #8. On the left side of module B, the repeating pattern of an alternating series of four adjacent negative terminals 243, 245, 247, 249, followed by a series of four adjacent positive terminals 251, 253, 255, 257 is represented by “−/−/−/−/+/+/+/+”. On the right side of module B, the repeating pattern of an alternating series of four adjacent positive terminals 259, 261, 263, 265 and four adjacent negative terminals 267, 269, 271, 273 is represented by “+/+/+/+/−/−/−/−”.

FIG. 22 shows a top plan view of a schematic example of a Type D battery module. Battery module D comprises a repeating sub-unit comprising eight stacked prismatic battery cells 200, 202, 204, etc. through 214 that are sequentially numbered #1, #2, #3, etc. through #8. The repeating pattern in this embodiment has two different, adjacent segments, i.e., first segment 310 and adjacent second segment 312. The pattern of alternating (staggered) negative terminals 275, 279 and alternating (staggered) positive terminals 277, 281 on the left side of module D in first segment 310 is represented by “−/+/−/+” in first segment 310. The reversed pattern of alternating (staggered) positive terminals 283, 287 and alternating (staggered) negative terminals 285, 291 on the left side of module D in adjacent second segment 312 is represented by “+/−/+/−”. Note the pair of adjacent positive terminals 281 and 283 at the fourth and fifth cells on the left side of module D, respectively, at a boundary separating first segment 310 from second segment 312.

Referring still to FIG. 22, on the right side of module D, the opposite pattern of alternating (staggered) positive terminals 293, 297 and alternating (staggered) negative terminals 295 and 299 in first segment 310 is represented by “+/−/+/−”. In second segment 312, the reversed pattern of alternating (staggered) negative terminals 301, 305 and alternating (staggered) positive terminals 303, 307 on the right side of module D in adjacent second segment 312 is represented by “−/+/−/+”. Note the pair of adjacent negative terminals 299 and 301 at the fourth and fifth cells on the right side of module D, respectively, at a boundary separating first segment 310 from second segment 312.

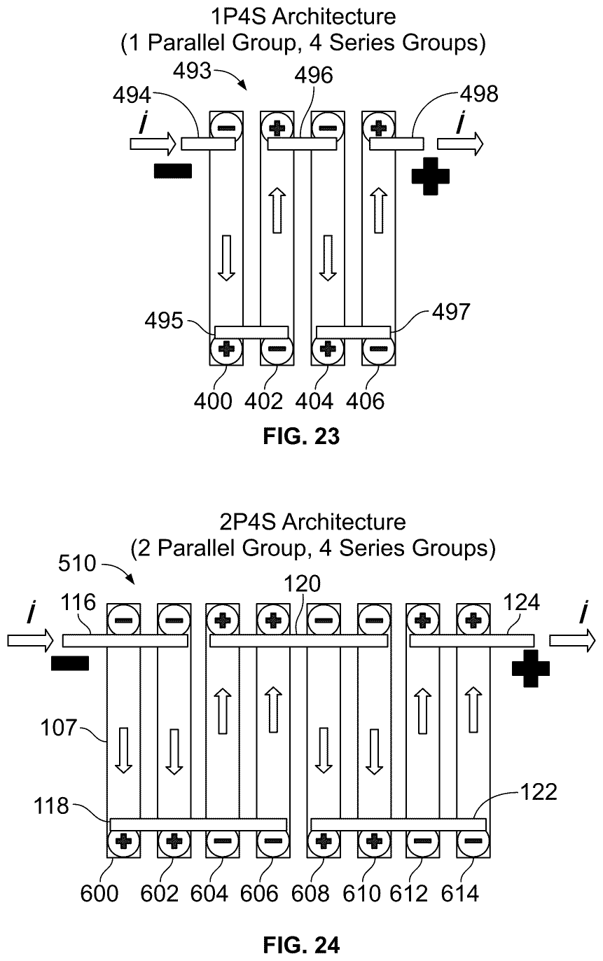

FIG. 23 shows a top plan view of a schematic example of a “1P4S” battery module architecture for module 493. Module 493 comprises four stacked prismatic battery cells 400, 402, 404, and 406 stacked with, or without, a thermal barrier (not shown) disposed in-between adjacent battery cells. First electrical bus 494 is electrically connected to the negative terminal of first cell 400, and brings DC inlet current, i into module 493. Second electrical bus 495 electrically connects the positive terminal of first cell 100 in series to the negative terminal of second cell 402. Next, third electrical bus 496 electrically connects the positive terminal of second cell 402 in series to the negative terminal of third cell 404. Next, fourth electrical bus 497 electrically connects the positive terminal of third cell 404 in series to the negative terminal of fourth cell 406. Finally, fifth electrical bus 498 carries DC outlet current, i, away from module 493. The interconnection architecture in this embodiment is an “1P4S” architecture, meaning that there is one parallel string with four battery cells connected in series for module 493. In this embodiment, the total number of cells, N, is an even number (i.e., N=4).

FIG. 24 shows a top plan view of a schematic example of a “2P4S” battery module architecture for module 510. Module 510 comprises eight stacked prismatic battery cells 600, 602, 604, 606, 608, 610, 612, and 614 stacked with, or without, a thermal barrier (not shown) disposed in-between adjacent battery cells. First in-line bus 116 is electrically connected to both the negative terminal of first cell 600 and to the negative terminal of second cell 602, and brings DC inlet current, i into module 510. Second in-line bus 118 electrically connects the positive terminal of first cell 600 to the positive terminal of second cell 602, and then connects (in series) to the negative terminal of third cell 604 and to the negative terminal of fourth cell 606. Third in-line bus 120 electrically connects the positive terminal of third cell 604 to the positive terminal of fourth cell 606, and then connects (in series) to the negative terminal of fifth cell 608 and to the negative terminal of sixth cell 610. Fourth in-line bus 122 electrically connects the positive terminal of fifth cell 608 to the positive terminal of sixth cell 610, and then connects (in series) to the negative terminal of seventh cell 612 and to the negative terminal of eighth cell 614. Finally, fifth in-line bus 124 electrically connects the positive terminal of seventh cell 612 to the positive terminal of eighth cell 614 and carries DC outlet current, i, away from module 510. The interconnection architecture illustrated in this embodiment is a “2P4S” architecture, meaning that there are two parallel strings with four battery cells connected in series for module 510. In this embodiment, the total number of cells, N, is an even number (i.e., N=8).

In an embodiment, a two-parallel (2P) battery module configuration may include two serial sub-modules, with cells connected in a staggered (alternating) pattern.

In an embodiment, a serially connected sub-module may include an “xP” battery module architecture, where x=1, 2, 3, etc. (i.e., 1P, 2P, 3P, etc.).

In an embodiment, the negative DC current inlet and the positive DC current outlet may be located on the same side of a battery module.

In an embodiment, a 2P cell group may be connected with every-other (i.e., alternating or alternative) cell to separate the effect of thermal excursion cell-to-cell heat conduction, busbar heat conduction, and short circuit resistance heating on different adjacent cells.

In an embodiment, one or more busbar dimensions may be optimized to achieve a desired electrical resistance for a particular cell-to-cell interconnection.

In an embodiment, the ICB tray may be extended to hang over (cantilevered over) cross-members to achieve a sufficiently large creepage spacing and packaging space efficiency.

In an embodiment, a C-shaped two-prong or four-prong busbar may be assembled using various methods, such as an ICB tray, lamination ICB, blister, or other formats, to offer design integration flexibility.

In an embodiment, a fuse feature may be incorporated into a busbar design that uses “1P” battery strings.

In an embodiment, a resistive bus, (i.e., a Rp bus), may be used to restrict shorting current inside a parallel cell group or an adjacent cell group. The electrical resistance, Rp, may be optimized to minimize the shorting current, while allowing for optimum cell balancing between cells or between parallel strings.

In an embodiment, a resistive bus feature may be incorporated into a “1p” string busbar design.

In an embodiment, a fuse feature may be used to reduce the number of voltage sense lines, and to reduce the heat generation due to parallel shorting during a thermal excursion event.

In an embodiment, the cells may be interconnected in an alternating way so that a parallel cell is not an adjacent cell.

In an embodiment, different “2P” interconnection architectures may be used to create a separation of parallel and adjacent cells.

In an embodiment, a two-busbar variation may include one straight (i.e., “in-line”) busbar connecting four adjacent cells and one four-pronged busbar connecting two adjacent cells and two alternating (alternative) cells.

In an embodiment, a two-busbar variation may include one shorter busbar connecting two adjacent cells and one longer busbar connecting two alternating (alternative) cells.

In an embodiment, a two-busbar variation may include one busbar connecting four alternative cells and another busbar connecting two adjacent cells and two alternating (alternative) cells.

In an embodiment, a one-busbar variation may connect together four alternating (alternative) cells.

In an embodiment, a thermal excursion propagation event may be reduced by distributing multiple heat sources caused by a thermal excursion event among several adjacent cells, rather than concentrating the multiple heat sources into a single, directly adjacent cell.

In an embodiment, a thermal excursion propagation event may be reduced by re-distributing the conduction heat from the busbar to a non-neighboring cell or cells.

In an embodiment, a reliance on using thermal barriers in-between adjacent battery cells, and/or active cooling capacity, may be reduced or eliminated by re-distributing the heat conduction from the busbar to one or more non-neighboring cell or cells.

In a first embodiment, a battery module includes at least eight, stacked prismatic battery cells, with each cell having a positive terminal and a negative terminal arranged in a variety of different alternating patterns (architectures).

In a related embodiment, the odd-numbered battery cells 1, 3, 5, etc. have a negative-to-positive polarity direction pointing forwards from left to right, while the even-numbered cells 2, 4, 6, etc. have a reversed negative-to-positive polarity negative-to-positive polarity direction pointing in the backwards direction, i.e., from right to left. This “staggered alternating single-cell” pattern, i.e., −/+/−/+ . . . repeats down the left side of a battery module. A similar, but reversed, pattern repeats down the right side of the module.

In another related embodiment, a first pair of adjacent battery cells both have a negative-to-positive polarity direction pointing forwards from left to right, while the next pair of adjacent cells both have a reversed negative-to-positive polarity direction pointing backwards from right to left. This “staggered alternating two-cell” pattern, i.e., −−/++/−−/++ . . . hat repeats down the left side of a battery module. A similar, but reversed, pattern repeats down the right side of the module.

In another related embodiment, a first group of four adjacent battery cells have a negative-to-positive polarity direction pointing forwards from left to right, while the next group of four adjacent cells both have a reversed negative-to-positive polarity direction pointing backwards from right to left. This “staggered alternating quadruple-cell” pattern, i.e. −−−−/++++/−−−−/++++ . . . repeats down the left side of a battery module. A similar, but reversed, pattern repeats down the right side of the module.

In a related embodiment, there are two adjacent segments of battery cells, i.e., segment A and adjacent segment B. In segment A, the odd-numbered cells 1 and 3 have a negative-to-positive polarity direction pointing forwards from left to right, while the even-numbered cells 2 and 4 have a reversed negative-to-positive polarity pointing backwards from right-to-left. Adjacent segment B flips this pattern backwards, where the odd-numbered cells 5 and 7 now have a reversed negative-to-positive polarity direction pointing backwards from right to left, while the even-numbered cells 6 and 8 have a negative-to-positive polarity negative-to-positive polarity direction pointing forwards from left-to-right. This “staggered alternating A/B” pattern, i.e., −/+/−/+/+/−/+/− . . . repeats down the left side of a battery module. A similar, but reversed, pattern repeats down the right side of the module.

In an embodiment, the layout of battery cells in a battery module is a “staggered alternating single-cell” pattern −/+/−/+. A first C-shaped electrical “overlap” bus interconnects the first negative battery terminal to the third positive terminal, and a second, interdigitated C-shaped electrical “overlap” bus interconnects the second negative battery terminal to the fourth positive terminal, and so on down the left side of the battery module. A similar, but reversed, interconnect configuration of interdigitated, C-shaped overlap buses is used for the right side of the module.

In one embodiment, a more-negative inlet to the battery module is located at a proximal end of the module, while a more-positive outlet is located at a distal end of the module.

In another embodiment, the more-negative inlet to the battery module is located at the proximal end of the module, while the more-positive outlet is also located at the proximal (i.e., same) end of the module.

In one embodiment, the total number of battery cells, N, in a battery module is an even number.

In another embodiment, the total number of battery cells, N, in a battery module is an odd number.

In an embodiment, the layout of battery cells in a battery module is a “staggered alternating single-cell” pattern −/+/−/+. A first, C-shaped electrical “overlap” bus interconnects the first negative battery terminal to the third positive terminal; and a second, interdigitated C-shaped electrical “overlap” bus interconnects the second negative battery terminal to the fourth positive terminal, and so on down the left side of the battery module. A similar, but reversed, set of interdigitated, C-shaped overlap buses are used down the right side of the module.

In an embodiment, the layout of battery cells in a battery module is a “staggered alternating single-cell” pattern −/+/−/+. A four-pronged “overlap” bus electrically interconnects the second positive terminal to the fourth positive terminal and to the fifth negative terminal and to the seventh negative terminal; which repeats down the left side of the battery module in an interdigitated fashion. On the right side of the module, a first in-line bus interconnects the first positive terminal to the second negative terminal and to the third positive terminal and to the fourth negative terminal. This pattern of in-line buses repeats down the right side of the battery module.

In an embodiment, the layout of battery cells in a battery module is a “staggered alternating two-cell” pattern ++/−−/++. A first, C-shaped “bypass” bus electrically interconnects the first positive terminal to the fourth negative terminal. A first, in-line bus interconnects the second positive terminal to the third negative terminal. These patterns repeat down the module. A first resistor may be connected across the first positive terminal and the second positive terminal. A second resistor may be connected across the third negative terminal and the fourth negative terminal. This pattern of interconnected resistors is repeated down the module.

In an embodiment, the layout of battery cells in a battery module is a “staggered alternating two-cell” pattern ++/−−/++/−−. A first, in-line bus electrically interconnects the first positive terminal to second positive terminal and to the third negative terminal and to the fourth negative terminal. These patterns repeat down the module. This example of an interconnection architecture is a “2P4S” pattern. A first fuse may be connected across the first positive terminal and the second positive terminal. A second fuse may be connected across the third negative terminal and the fourth negative terminal. This pattern of interconnected fuses is repeated down the module.

In an embodiment, the layout of battery cells in a battery module is a “staggered alternating one-cell” pattern: −/+/−/+. A first, four-pronged C-shaped overlap bus interconnects the second positive terminal to the fourth positive terminal and to the fifth negative terminal and to the seventh negative terminal, on the left side of the module. On the right side of the module is a first, in-line bus that interconnects the first positive terminal to the second negative terminal and to the third positive terminal and to the fourth negative terminal. These patterns repeat down the module.

In an embodiment, the layout of battery cells in a battery module is a “staggered alternating one-cell” pattern: −/+/−/+. A first, C-shaped overlap bus interconnects the first negative terminal to the third negative terminal. A second, interdigitated C-shaped overlap bus interconnects that second positive terminal to the fourth positive terminal. A first diagonal bus interconnects the fourth positive terminal to the adjacent fifth negative terminal. These patterns repeat down the module.

In an embodiment, the layout of battery cells is a staggered alternating quadruple cell” pattern: −−−−/++++/−−−−/++++. A first, four-pronged, non-uniformly-spaced apart, C-shaped overlap bus interconnects the second negative terminal to the fourth negative terminal and to the fifth positive terminal and to the seventh positive terminal on the left side. On the right side, a second, four-pronged, uniformly-spaced apart, C-shaped overlap bus interconnects the first positive terminal to the third positive terminal and to the fifth negative terminal and to the seventh negative terminal. These patterns repeat down the module.

In an embodiment, the layout of battery cells in a battery module is a “staggered alternating one-cell” pattern: −/+/−/+. A first, four-pronged, uniformly-spaced apart, C-shaped overlap bus interconnects the fifth positive terminal to the seventh positive terminal and to the ninth negative terminal and to the eleventh negative terminal on the left side. On the right side, a second, four-pronged, uniformly-spaced apart, C-shaped overlap bus interconnects the first positive terminal to the third positive terminal and to the fifth negative terminal and to the seventh negative terminal. These patterns repeat down the module.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. All embodiments and examples disclosed herein are non-limiting embodiments and non-limiting examples. The words “a”, “an”, “the”, “at least one”, and “one or more” are used interchangeably to indicate that at least one of the items is present.

Moreover, words of approximation, such as “about,” “almost,” “substantially,” “generally,” “approximately,” and the like, may each be used herein to denote “at, near, or nearly at,” or “within 0-10% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

What is claimed is:

1. A battery module, comprising:
a first prismatic repeating battery sub-unit comprising:
four adjacent positions, including a position #1, a position #2, a position #3, and a position #4, defined within the first prismatic repeating sub-unit, and stacked in increasing order from the position #1 to the position #2 to the position #3 to the position #4;
a first prismatic battery cell located at the position #1, comprising a first positive terminal and a first negative terminal;
a second prismatic battery cell located at the position #2, comprising a second positive terminal and a second negative terminal;
a third prismatic battery cell located at the position #3, comprising a third positive terminal and a third negative terminal;
a fourth prismatic battery cell located at the position #4, comprising a fourth positive terminal and a fourth negative terminal; and
a second, prismatic repeating battery sub-unit located adjacent to the first prismatic repeating battery sub-unit, comprising:
four additional adjacent positions, including a position #5, a position #6, a position #7, and a position #8, defined within the second, prismatic repeating battery sub-unit, and stacked in increasing order from the position #5 to the position #6 to the position #7 to the position #8;
a fifth prismatic battery cell located at the position #5, comprising a fifth positive terminal and a fifth negative terminal;
a sixth prismatic battery cell located at the position #6, comprising a sixth positive terminal and a sixth negative terminal;
a seventh prismatic battery cell located at the position #7, comprising a seventh positive terminal and a seventh negative terminal; and
an eighth prismatic battery cell located at the position #8, comprising an eighth positive terminal and an eighth negative terminal.

2. The battery module of claim 1,
wherein the battery module has a first side and an opposing second side;
wherein the first, second, fifth, and sixth positive terminals are located on the opposing second side of the battery module;
wherein the third, fourth, seventh, and eighth positive terminals are located on the first side of the battery module;
wherein the first, second, fifth, and sixth negative terminals are located on the first side of the battery module; and
wherein the third, fourth, seventh, and eighth negative terminals are located on the opposing second side of the battery module.

3. The battery module of claim 2, further comprising:
a first bus electrically connecting the first negative terminal to the third positive terminal;
a second bus electrically connecting the second negative terminal to the fourth positive terminal;
a third bus electrically connecting the third negative terminal to the fifth positive terminal;
a fourth bus electrically connecting the fourth negative terminal to the sixth positive terminal;
a fifth bus electrically connecting the fifth negative terminal to the seventh positive terminal;
a sixth bus electrically connecting the sixth negative terminal to the eighth positive terminal;
a seventh bus electrically connecting the first positive terminal to the second positive terminal; and
an eighth bus electrically connecting the seventh negative terminal to the eighth negative terminal.

4. The battery module of claim 3,
wherein the first, second, third, fourth, fifth, and sixth bus are C-shaped;
wherein the first bus and the second bus are interdigitated together;
wherein the third bus and the fourth bus are interdigitated together;
wherein the fifth bus and the sixth bus are interdigitated together;
wherein the seventh bus is an in-line bus; and
wherein the eighth bus is an in-line bus.

5. The battery module of claim 2, further comprising:
a third prismatic repeating battery sub-unit comprising:
a ninth position #9, defined within the third prismatic repeating battery sub-unit, and stacked adjacent to position #8 of the second prismatic repeating battery sub-unit; and
a ninth prismatic battery cell located at the ninth stack position #9, comprising a ninth positive terminal and a ninth negative terminal; and
a first bus electrically connecting the second positive terminal to the fourth negative terminal;
a second bus electrically connecting the fourth positive terminal to the sixth negative terminal;
a third bus electrically connecting the sixth positive terminal to the eighth negative terminal;
a fourth bus electrically connecting the first negative terminal to the third positive terminal;
a fifth bus electrically connecting the third negative terminal to the fifth positive terminal;
a sixth bus electrically connecting the fifth negative terminal to the seventh positive terminal;
a seventh bus electrically connecting the seventh negative terminal to the ninth positive terminal;
an eighth bus electrically connecting the eighth positive terminal to the ninth negative terminal;
a more-negative input bus connected to the second negative terminal; and
a more-positive output bus connected to the first positive terminal.

6. The battery module of claim 5,
wherein the first, second, third, fourth, fifth, and sixth bus are C-shaped;
wherein the first bus and the fifth bus are interdigitated together;
wherein the second bus and the sixth bus are interdigitated together;
wherein the third bus and the seventh bus are interdigitated together; and
wherein the eighth bus is an in-line bus.

7. The battery module of claim 2, further comprising:
a first bus electrically connecting the first positive terminal to the second positive terminal and to the third negative terminal and to the fourth negative terminal;
a second bus electrically connecting the fifth positive terminal to the sixth positive terminal and to the seventh negative terminal and to the eighth negative terminal;
a third bus electrically connecting the first negative terminal to the second negative terminal;
a fourth bus electrically connecting the third positive terminal to the fourth positive terminal and to the fifth negative terminal and to the sixth negative terminal; and
a fifth bus electrically connecting the seventh positive terminal to the eighth positive terminal.

8. The battery module of claim 7, further comprising:
a first fuse disposed in-between the first positive terminal and the second positive terminal;
a second fuse disposed in-between the third negative terminal and the fourth negative terminal;
a third fuse disposed in-between the fifth positive terminal and the sixth positive terminal;
a fourth fuse disposed in-between the seventh negative terminal and the eighth negative terminal;
a fifth fuse disposed in-between the first negative terminal and the second negative terminal;
a sixth fuse disposed in-between the third positive terminal and the fourth positive terminal;
a seventh fuse disposed in-between the fifth negative terminal and the sixth negative terminal; and
an eighth fuse disposed in-between the seventh positive terminal and the eighth positive terminal.

9. The battery module of claim 2, further comprising;
a first resistor disposed in-between the first positive terminal and the second positive terminal;
a second resistor disposed in-between the third negative terminal and the fourth negative terminal;
a third resistor disposed in-between the fifth positive terminal and the sixth positive terminal;
a fourth resistor disposed in-between the seventh negative terminal and the eighth negative terminal;
a fifth resistor disposed in-between the third positive terminal and the fourth positive terminal; and
a sixth resistor disposed in-between the fifth negative terminal and the sixth negative terminal.

10. The battery module of claim 2, further comprising:
a first bus electrically connecting the first positive terminal to the fourth negative terminal;
a second bus electrically connecting the second positive terminal to the third negative terminal;
a third bus electrically connecting the fifth positive terminal to the eighth negative terminal;
a fourth bus electrically connecting the sixth positive terminal to the seventh negative terminal;
a fifth bus electrically connecting the first negative terminal to the second negative terminal;
a sixth bus electrically connecting the third positive terminal to the sixth negative terminal;
a seventh bus electrically connecting the fourth positive terminal to the fifth negative terminal; and
an eighth bus electrically connecting the seventh positive terminal to the eighth positive terminal; and
a first fuse disposed in-between the first positive terminal and the second positive terminal;
a second fuse disposed in-between the third negative terminal and the fourth negative terminal;
a third fuse disposed in-between the fifth positive terminal and the sixth positive terminal;
a fourth fuse disposed in-between the seventh negative terminal and the eighth negative terminal;
a fifth fuse disposed in-between the third positive terminal and the fourth positive terminal; and
a sixth fuse disposed in-between the fifth negative terminal and the sixth negative terminal.

11. The battery module of claim 1,
wherein the battery module has a first side and an opposing second side;
wherein the second, fourth, sixth, and eighth positive terminals are located on the first side of the battery module;
wherein the first, third, fifth, and seventh positive terminals are located on the opposing second side of the battery module;
wherein the second, fourth, sixth, and eighth negative terminals are located on the opposing second side of the battery module; and
wherein the first, third, fifth, and seventh negative terminals are located on the first side of the battery module.

12. The battery module of claim 11, further comprising:
a first bus electrically connecting the first negative terminal to the third negative terminal;
a second bus electrically connecting the second positive terminal to the fourth positive terminal and to the fifth negative terminal and to the seventh negative terminal;
a third bus electrically connecting the first positive terminal to the second negative terminal and to the third positive terminal and to the fourth negative terminal;
a fourth bus electrically connecting the fifth positive terminal to the sixth negative terminal and to the seventh positive terminal and to the eighth negative terminal; and
a fifth bus electrically connecting the sixth positive terminal to the eighth positive terminal.

13. The battery module of claim 12,
wherein the first bus is C-shaped;
wherein the second bus comprises four interdigitated prongs;
wherein the third bus comprises a first in-line electrical bus; and
wherein the fourth bus comprises a second in-line electrical bus.

14. The battery module of claim 11, further comprising:
a first bus electrically connecting the first negative terminal to the third negative terminal;
a second bus electrically connecting the second positive terminal to the fourth positive terminal;
a third bus electrically connecting the fifth negative terminal to the seventh negative terminal;
a fourth bus electrically connecting the sixth positive terminal to the eighth positive terminal;
a fifth bus electrically connecting the first positive terminal to the third positive terminal;
a sixth bus electrically connecting the second negative terminal to the fourth negative terminal;
a seventh bus electrically connecting the fifth positive terminal to the seventh positive terminal;
an eighth bus electrically connecting the sixth negative terminal to the eighth negative terminal;
a ninth bus electrically connecting the second negative terminal to the third positive terminal;
a tenth bus electrically connecting the fourth positive terminal to the fifth negative terminal; and
an eleventh bus electrically connecting the sixth negative terminal to the seventh positive terminal.

15. The battery module of claim 1,
wherein the battery module has a first side and an opposing second side;
wherein the first, second, third, and fourth negative terminals are located on the first side of the battery module;
wherein the first, second, third, and fourth positive terminals are located on the opposing second side of the battery module;
wherein the fifth, six, seventh, and eighth positive terminals are located on the first side of the battery module; and
wherein the fifth, six, seventh, and eighth negative terminals are located on the opposing second side of the battery module.

16. The battery module of claim 15, further comprising:
a first bus electrically connecting the first negative terminal to the third negative terminal;
a second bus electrically connecting the second negative terminal to the fourth negative terminal and to the fifth positive terminal and to the seventh positive terminal;
a third bus electrically connecting the first positive terminal to the third positive terminal and to the fifth negative terminal and to the seventh negative terminal; and
a fourth bus electrically connecting the second positive terminal to the fourth positive terminal and to the sixth negative terminal and to the eighth negative terminal.

17. The battery module of claim 1,
wherein the battery module has a first side and an opposing second side;
wherein the first, third, sixth, and eighth negative terminals are located on the first side of the battery module;
wherein the first, third, sixth, and eighth positive terminals are located on the opposing second side of the battery module;
wherein the second, fourth, fifth, and seventh positive terminals are located on the first side of the battery module; and
wherein the second, fourth, fifth, and seventh negative terminals are located on the opposing second side of the battery module.

18. The battery module of claim 17, further comprising:
a first bus electrically connecting the first negative terminal to the third negative terminal;
a second bus electrically connecting the second positive terminal to the fourth positive terminal;
a third bus electrically connecting the first positive terminal to the third positive terminal and to the fifth negative terminal and to the seventh negative terminal; and
a fourth bus electrically connecting the second negative terminal to the fourth negative terminal and to the sixth positive terminal and to the eighth positive terminal.

19. A battery module, comprising:
a first prismatic repeating battery sub-unit comprising:
four adjacent positions, including a position #1, a position #2, a position #3, and a position #4, defined within the first prismatic repeating battery sub-unit, and stacked in increasing order from the position #1 to the position #2 to the position #3 to the position #4;
a first prismatic battery cell located at the position #1, comprising a first positive terminal and a first negative terminal;
a second prismatic battery cell located at the position #2, comprising a second positive terminal and a second negative terminal;
a third prismatic battery cell located at the position #3, comprising a third positive terminal and a third negative terminal;
a fourth prismatic battery cell located at the position #4, comprising a fourth positive terminal and a fourth negative terminal; and
a second, prismatic repeating battery sub-unit located adjacent to the first prismatic repeating battery sub-unit, comprising:
four additional adjacent positions, including a position #5, a position #6, a position #7, and a position #8, defined within the second, adjacent prismatic repeating battery sub-unit, and stacked in increasing order from the position #5 to the position #6 to the position #7 to the position #8;
a fifth prismatic battery cell located at the position #5, comprising a fifth positive terminal and a fifth negative terminal;
a sixth prismatic battery cell located at the position #6, comprising a sixth positive terminal and a sixth negative terminal;
a seventh prismatic battery cell located at the position #7, comprising a seventh positive terminal and a seventh negative terminal; and
an eighth prismatic battery cell located at the position #8, comprising an eighth positive terminal and an eighth negative terminal; and
a first bus electrically connecting the second positive terminal to the fourth positive terminal and to the fifth negative terminal and to the seventh negative terminal;
a second bus electrically connecting the sixth positive terminal to the eighth positive terminal and to the ninth negative terminal and to the eleventh negative terminal;
a third bus electrically connecting the first positive terminal to the second negative terminal and to the third positive terminal and to the fourth negative terminal; and
a fourth bus electrically connecting the fifth positive terminal to the sixth negative terminal and to the seventh positive terminal and to the eighth negative terminal;
wherein the battery module has a first side and an opposing second side;
wherein the second, fourth, sixth, and eighth positive terminals are located on the first side of the battery module;
wherein the first, third, fifth, and seventh positive terminals are located on the opposing second side of the battery module;
wherein the second, fourth, sixth, and eighth negative terminals are located on the opposing second side of the battery module; and
wherein the first, third, fifth, and seventh negative terminals are located on the first side of the battery module.

20. A vehicle comprising:
a vehicle body;
a road wheel rotatably attached to the vehicle body;
an electric traction drive motor rotatably attached to the road wheel;
a battery tray attached to the vehicle body; and
a battery module attached to the battery tray and electrically connected to the electric traction drive motor;
wherein the battery module comprises:
a first prismatic repeating battery sub-unit comprising:
four adjacent positions, including a position #1, a position #2, a position #3, and a position #4, defined within the first prismatic repeating battery sub-unit, and stacked in increasing order from the position #1 to the position #2 to the position #3 to the position #4;
a first prismatic battery cell located at the position #1, comprising a first positive terminal and a first negative terminal;
a second prismatic battery cell located at the position #2, comprising a second positive terminal and a second negative terminal;
a third prismatic battery cell located at the position #3, comprising a third positive terminal and a third negative terminal;
a fourth prismatic battery cell located at the position #4, comprising a fourth positive terminal and a fourth negative terminal; and
a second, prismatic repeating battery sub-unit located adjacent to the first prismatic repeating battery sub-unit, comprising:
four additional adjacent positions, including a position #5, a position #6, a position #7, and a position #8, defined within the second, adjacent prismatic repeating battery sub-unit, and stacked in increasing order from the position #5 to the position #6 to the position #7 to the position #8;
a fifth prismatic battery cell located at the position #5, comprising a fifth positive terminal and a fifth negative terminal;
a sixth prismatic battery cell located at the position #6, comprising a sixth positive terminal and a sixth negative terminal;
a seventh prismatic battery cell located at the position #7, comprising a seventh positive terminal and a seventh negative terminal; and
an eighth prismatic battery cell located at the position #8, comprising an eighth positive terminal and an eighth negative terminal; and
a first bus electrically connecting the first positive terminal to the third negative terminal;
a second bus electrically connecting the second positive terminal to the fourth negative terminal;
a third bus electrically connecting the third positive terminal to the fifth negative terminal;
a fourth bus electrically connecting the fourth positive terminal to the sixth negative terminal;
a fifth bus electrically connecting the fifth positive terminal to the seventh negative terminal;
a sixth bus electrically connecting the sixth positive terminal to the eighth negative terminal;
a seventh bus electrically connecting the first positive terminal to the second positive terminal; and
an eighth bus electrically connecting the seventh negative terminal to the eighth negative terminal; and
wherein the battery module has a first side and an opposing second side;
wherein the first, second, fifth, and sixth positive terminals are located on the opposing second side of the battery module;
wherein the third, fourth, seventh, and eighth positive terminals are located on the first side of the battery module;
wherein the first, second, fifth, and sixth negative terminals are located on the first side of the battery module; and
wherein the third, fourth, seventh, and eighth negative terminals are located on the opposing second side of the battery module.
